(19) United States
(12) Patent Application Publication
(10) Pub. No.: US 2013/0170016 A1
(43) Pub. Date: Jul. 4, 2013

(54) PHOTOREFRACTIVE DEVICE CONTAINING A CHROMOPHORE-DOPED POLYMER LAYER AND ITS MANUFACTURING METHOD

(71) Applicants: Wan-Yun Hsieh, San Diego, CA (US); Weiping Lin, Carlsbad, CA (US); Tao Gu, San Diego, CA (US); Peng Wang, San Diego, CA (US); Michiharu Yamamoto, Carlsbad, CA (US)

(72) Inventors: Wan-Yun Hsieh, San Diego, CA (US); Weiping Lin, Carlsbad, CA (US); Tao Gu, San Diego, CA (US); Peng Wang, San Diego, CA (US); Michiharu Yamamoto, Carlsbad, CA (US)

(73) Assignee: NITTO DENKO CORPORATION, Osaka (JP)

(21) Appl. No.: 13/823,092

(22) PCT Filed: Sep. 13, 2011
(86) PCT No.: PCT/US2011/051423

§ 371 Date: Mar. 13, 2013

Related U.S. Application Data
(60) Provisional application No. 61/383,278, filed on Sep. 15, 2010.

(51) Int. Cl. G02F 1/00

(52) U.S. Cl. CPC G02F 1/0009
USPC 359/299; 427/74

(57) ABSTRACT

A photorefractive device (100) and method of manufacture are disclosed. The device (100) comprises a layered structure, in which one or more chromophore-doped polymer layers (110) are interposed between a photorefractive material (106) and one or more electrode layers (104). The layered structure can also be interposed between a plurality of substrates (102). In some embodiments, the device (100) exhibits a decreased decay time when applying the biased voltage. Concurrently, the device (100) of the present disclosure utilizes approximately half the bias voltage, advantageously resulting in a longer device life time.

### BACKGROUND OF THE INVENTION

1. Field of the Invention

The invention relates to photorefractive devices comprising one or more chromophore-doped polymer layers. The photorefractive device exhibits improved performance, such as fast grating decay times. Also disclosed are methods of making the photorefractive device.

2. Description of the Related Art

Photorefractivity is a phenomenon in which the refractive index of a material can be altered by changing the electric field within the material, such as by laser beam irradiation. The change of the refractive index may be achieved by, for example, steps including: (1) charge generation by laser irradiation; (2) charge transport, resulting in the separation of positive and negative charges; (3) trapping of one type of charge (charge delocalization), (4) formation of a non-uniform internal electric field (space-charge field) as a result of charge delocalization, and (5) refractive index change induced by the non-uniform electric field. Therefore, materials that combine good charge generation, good charge transport or photoconductivity, and good electro-optical activity can exhibit good photorefractive properties.

Photorefractive materials have many promising applications, such as high-density optical data storage, dynamic holography, optical image processing, phase conjugated mirrors, optical computing, parallel optical logic, and pattern recognition. Originally, the photorefractive effect was found in a variety of inorganic electro-optical (EO) crystals, such as LiNbO₃. In these materials, the mechanism of the refractive index modulation by the internal space-charge field is based on a linear electro-optical effect. Usually inorganic EO crystals do not require biased voltage for the photorefractive behavior.

In 1990 and 1991, the first organic photorefractive crystal and polymeric photorefractive materials were discovered and reported. Such materials are disclosed, for example, in U.S. Pat. No. 5,064,264, which is hereby incorporated by reference in its entirety. Organic photorefractive materials offer many advantages over the original inorganic photorefractive crystals, such as large optical non-linearities, low dielectric constants, low cost, light weight, structural flexibility, and ease of device fabrication. Other important characteristics that may be desirable, depending on the application, include sufficiently long shelf life, optical quality, and thermal stability. These kinds of active organic polymers are emerging as key materials for advanced information and telecommunication technology.

In recent years, researchers have attempted to optimize the properties of organic, and particularly polymeric, photorefractive materials. As mentioned above, good photorefractive properties depend upon good charge generation, good charge transport—also known as photoconductivity—and good electro-optical activity. Some researchers have investigated how various components affect the properties of photorefractive materials. As an example, materials containing carbazole can impart photoconductivity, while phenyl amine groups can improve charge transport properties.

Most notably, several new organic photorefractive compositions were developed having improved photorefractive properties, such as high diffraction efficiency, fast response time, and long phase stabilities. For example, see U.S. Pat. Nos. 6,809,156, 6,653,421, 6,646,107, 6,610,809 and U.S. Patent Application Publication No. 2004/0077794, which is hereby incorporated by reference in its entirety. These references disclose materials and processes for making triphenyl diamine (TPD)-type photorefractive compositions that show very fast response times and good gain coefficients.

Typically, applying a high biased voltage to photorefractive materials can obtain good photorefractive behavior. While applying a high biased voltage may result in a longer grating persistency, the application of the high voltage in photorefractive material may also cause the photorefractive grating to disappear almost immediately after stopping the applied high biased voltage. Therefore, there is a strong need to improve the properties of photorefractive devices, including for example, by improving the decay time of the gratings, even after reducing or eliminating the applied biased voltage.

### SUMMARY OF THE INVENTION

Described herein are photorefractive devices that comprise one or more electrode layers, a layer that includes a photorefractive material, and one or more polymer layers interposed between the one or more electrode layers and the layer comprising the photorefractive material, wherein the one or more polymer layers is doped with one or more chromophores. In some embodiments, the one or more polymer layers is non-photorefractive. In some embodiments, the photorefractive device exhibits a decreased grating decay time relative to a second photorefractive device having one or more polymer layers that are not doped with one or more chromophores. In some embodiments, the photorefractive device exhibits a decreased grating response time relative to a second photorefractive device having polymer layers that are not doped with chromophores. In an embodiment, the grating decay time and peak bias voltage are measured using a 532 nm laser beam.

In some embodiments, the one or more chromophore-doped polymer layers comprise a polymer selected from the group consisting of polymethyl methacrylate, polyimide, amorphous polycarbonate, and siloxane sol-gel. In some embodiments, the one or more chromophore-doped polymer layers comprise a chromophore selected from 4-homopiperidino-2-fluorobenzylidene malononitrile (“7-FDCST”), 1-hexamethyleneimine-4-nitrobenzene, methyl 3-(4-(azepan-1-yl)phenyl)acrylate, and combinations thereof.

In some embodiments, the photorefractive device exhibits a grating decay time of about 130 seconds or less. In some embodiments, the photorefractive device exhibits a grating decay time of about 44 seconds or less. In some embodiments, the photorefractive device exhibits a grating decay time of about 14 seconds or less. In some embodiments, the one or more chromophore-doped polymer layers have a total combined thickness of about 2 μm to about 40 μm. In some embodiments, the one or more chromophore-doped polymer layers have a total combined thickness of about 10 μm to about 40 μm. In some embodiments, the one or more chromophore-doped polymer layers have a total combined thickness of about 10 μm to about 20 μm. In some embodiments, the one or more chromophore-doped polymer layers have a total combined thickness of about 20 μm to about 40 μm.

In some embodiments, the photorefractive device further comprises a substrate on one side of the first electrode layer, with the chromophore-doped polymer layer being on the other side of the first electrode layer opposite to the substrate. In an embodiment, the substrate comprises at least one of soda lime glass, silica glass, borosilicate glass, gallium nitride, gallium arsenide, sapphire, quartz glass, polyethylene terephthalate, and polycarbonate.

In some embodiments, the photorefractive device comprises a first electrode layer and a second electrode layer disposed on opposite sides of a photorefractive material, a first chromophore-doped polymer layer interposed between the first electrode layer and the photorefractive material, and a second chromophore-doped polymer layer interposed between the second electrode layer and the photorefractive material. In some embodiments, the photorefractive device comprises a first substrate disposed on a side of the first electrode layer opposite the photorefractive material; and a second substrate disposed on a side of the second electrode layer opposite the photorefractive material, wherein the first substrate and the second substrate each independently comprise a material selected from the group consisting of soda lime glass, silica glass, borosilicate glass, gallium nitride, gallium arsenide, sapphire, quartz glass, polyethylene terephthalate, and polycarbonate.

Also disclosed herein are methods for fabricating a photorefractive device, comprising interposing a first chromophore-doped polymer layer between a first electrode layer and a photorefractive material. In some embodiments, the method comprises interposing a second chromophore-doped polymer layer between a second electrode layer and the photorefractive material, wherein the photorefractive device has the first electrode layer and the second electrode layer on opposite sides of the photorefractive material. In some embodiments, the method comprises applying a mixture to the first electrode layer, wherein said mixture comprises a chromophore and a polymer dispersed in a solvent, and removing the solvent from the applied mixture to form the first chromophore-doped polymer layer on the first electrode layer.

In some embodiments, the mixture is prepared by a process that comprises substantially dissolving about 10% to 45% by weight of the polymer in the solvent to obtain a polymer solution, and intermixing about 0.1 to about 10 parts by weight of the chromophore per 100 parts of the total polymer and chromophore into the polymer solution to obtain the mixture. In some embodiments, the chromophore is selected from 4-homopiperidino-2-fluorobenzylidene malononitrile, 1-hexamethyleneimine-4-nitrobenzene, methyl 3-(4-(azepan-1-yl)phenyl)acrylate, and combinations thereof. In some embodiments, the polymer is amorphous polycarbonate (APC).

### BRIEF DESCRIPTION OF THE DRAWINGS

FIG. 1A illustrates an embodiment (not to scale) in which one chromophore-doped polymer layer is interposed between an electrode layer and a photorefractive material.

FIG. 1B illustrates an embodiment (not to scale) in which two chromophore-doped polymer layers are interposed between an electrode layer and a photorefractive material on both sides of the photorefractive material.

FIG. 2A illustrates an embodiment (not to scale) in which one chromophore-doped polymer layer is interposed between an electrode layer and a photorefractive material on one side of the photorefractive material.

FIG. 2B illustrates an embodiment (not to scale) in which two chromophore-doped polymer layers are interposed between an electrode layer and a photorefractive material on both sides of the photorefractive material.

FIGS. 3A and 3B provide chemical structures for exemplary chromophores according to the general formula (VII).

FIG. 4 provides chemical structures for exemplary chromophores according to the general formula (VIII).

### DETAILED DESCRIPTION

The present disclosure relates to photorefractive devices comprising at least one electrode layer and a photorefractive material. For example, the photorefractive material can be composed of a unique layer. One or more chromophore-doped polymer layers can be interposed between the one or more electrode layers and the photorefractive material, where the grating decay time of the photorefractive device after incorporating the one or more chromophore-doped polymer layers is reduced. Advantageously, as discussed in greater detail below, doping polymer layers with one or more chromophores can decrease the grating response and decay time. These lower times can permit faster updates (e.g., erasing and writing) to the signal recorded within a photorefractive device. Accordingly, the present application provides photorefractive devices that may provide various utilities including, but not limited to, holographic data storage and image recording materials and devices.

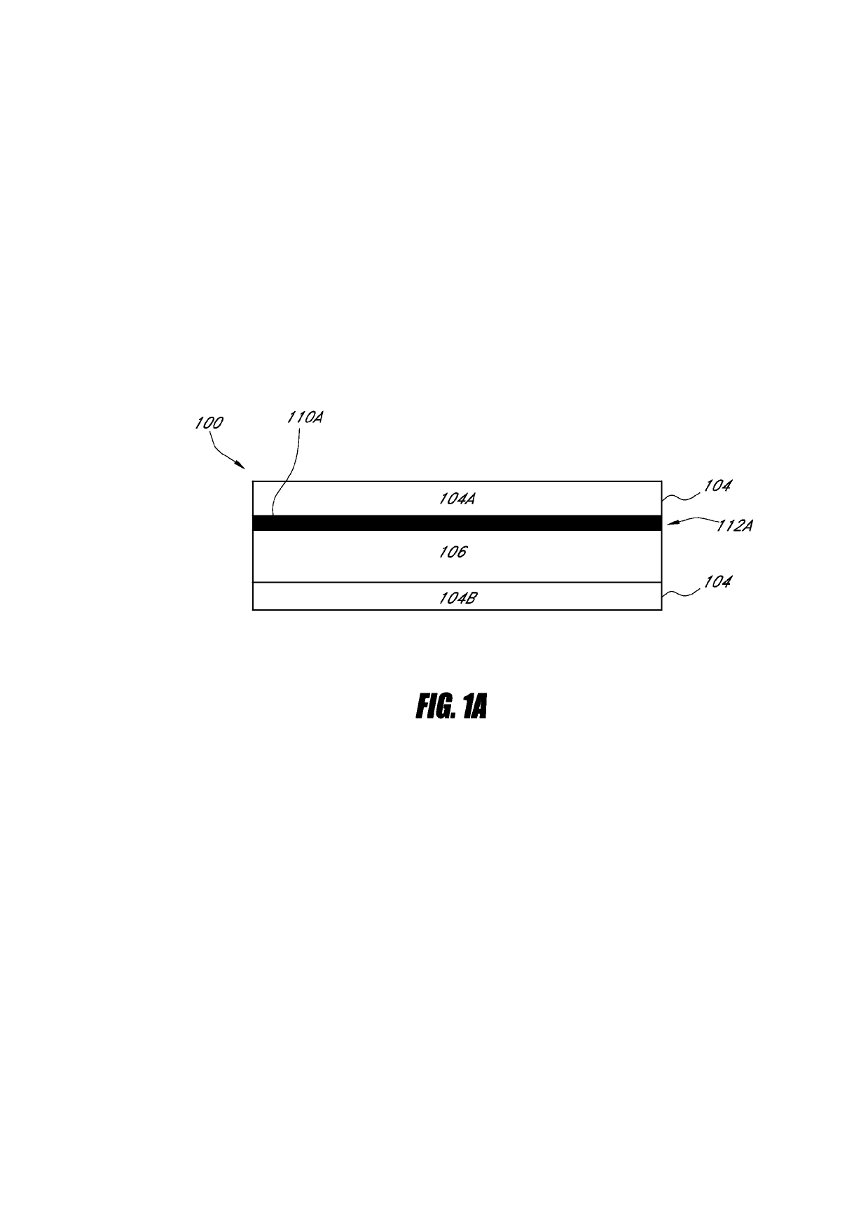

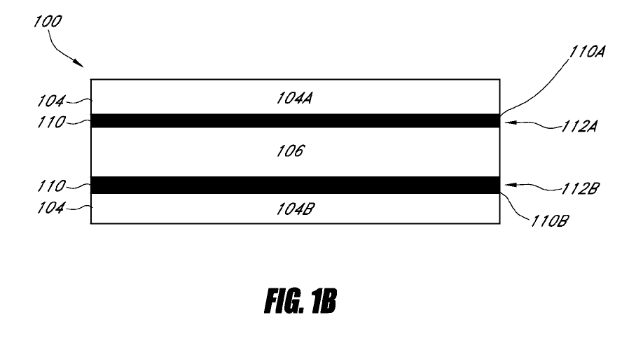

FIGS. 1A and 1B illustrate a portion of one embodiment of a photorefractive device 100, comprising one or more electrode layers 104 and a photorefractive material 106. In one embodiment, first and second electrode layers 104A, 104B are positioned on opposite sides of the photorefractive material 106. The first and second electrode layers 104A, 104B may comprise the same materials or different materials, as discussed below.

The photorefractive material can have a variety of thickness values for use in a photorefractive device. In an embodiment, the photorefractive material is about 10 μm to about 200 μm thick. In an embodiment, the photorefractive material is about 25 μm to about 100 μm thick. Such ranges of thickness allow for the photorefractive material to provide good grating behavior.

One or more chromophore-doped polymer layers 110 are also interposed between the electrode layers 104A, 104B and the photorefractive material 106. In one embodiment, illustrated in FIG. 1A, a first chromophore-doped polymer layer 110A is interposed between the first electrode layer 104A and the photorefractive material 106. In an alternative embodiment, as illustrated in FIG. 1B, the embodiment of FIG. 1A is modified such that a second chromophore-doped polymer layer 110B is interposed between the second electrode layer 104B and the photorefractive material 106. The first and second chromophore-doped polymer layers 110A, 110B may comprise the same material or different materials, as discussed below. For example, the type of polymer can be the same or different. Furthermore, the type of chromophore, if incorporated into the polymer, can be the same or different. The thicknesses of each of the polymer layers may optionally be different.

In one embodiment, the chromophore-doped polymer layers 110 are applied to the one or more electrode layers 104 by techniques known to those skilled in the art, including, but not limited to, spin coating and solvent casting. The photorefractive material 106 is subsequently mounted to the polymer layer modified electrodes 104. Preferably, one or more of the polymer layers 110 comprise a chromophore.

In one embodiment, the one or more chromophore-doped polymer layers 110 comprise a single layer having selected thicknesses 112A, 112B. In an alternative embodiment, the polymer layer 110 comprises more than one layer, where the total thickness 112A, 112B of all the layers of the polymer layer 110 is approximately equal to the selected thickness 112A, 112B. The selected thicknesses 112A, 112B may be independently selected, as necessary. In an embodiment, the total combined thicknesses for 112A and 112B of the polymer layers 110 range from about 2 μm to about 40 μm. In an embodiment, the total combined thicknesses for 112A and 112B of the polymer layers 110 range from about 2 μm to about 30 μm. In an embodiment, the total combined thicknesses for 112A and 112B range from about 2 μm to about 20 μm. In an embodiment, the total combined thicknesses for 112A and 112B range from about 10 μm to about 40 μm. In an embodiment, the total combined thicknesses for 112A and 112B range from about 10 μm to about 20 μm. In an embodiment, the total combined thicknesses for 112A and 112B range from about 20 μm to about 40 μm. In one non-limiting example, the total combined thicknesses for 112A and 112B of the polymer layers 110 are each about 20 μm. Other examples of the total combined thicknesses for 112A and 112B include about 15 μm, about 10 μm, about 5 μm, and about 2 μm.

When more than one polymer layer is present, not all of the polymer layers need to comprise a chromophore. In an embodiment, one or more polymer layers comprise one or more chromophores. In an embodiment, two or more polymer layers comprise one or more chromophores. In an embodiment, more than two polymer layers comprise one or more chromophores. In still another embodiment, all of the polymer layers comprise one or more chromophores.

In one embodiment, polymer layer 110 comprises a polymer exhibiting a low dielectric constant and a chromophore for doping the polymer. The polymer may exhibit, for example, a relative dielectric constant from about 2 to about 15, and more preferably ranges from about 2 to about 4.5. In some embodiments, the refractive index of the polymer layers 110 can be from about 1.5 to about 1.7. The polymer layers 110 can include, for example, polymethyl methacrylate (PMMA), polyimide, amorphous polycarbonate (APC), and siloxane sol-gel. These materials can be used singly or in combination. For example, the one or more chromophore-doped polymer layers 110 can comprise any single polymer, a mixture of two or more polymers, multiple layers that each comprise a different polymer, or combinations thereof.

At least one polymer layer is doped with a chromophore. As used herein, a “chromophore” is defined as any chemical molecule or group that provides non-linear optical functionality to a material. Despite the presence of chromophore in the polymer layer, the polymer layer may not be photorefractive, e.g. particularly compared to the photorefractive material. In an embodiment, the one or more polymer layers are not, themselves, photorefractive. In some embodiments, the chromophore includes a conjugated pi system. In some embodiments, the chromophore includes a metal complex.

The chromophore, in some embodiments, can be dispersed in one or more polymer layers. For example, U.S. Pat. No. 5,064,264, which is hereby incorporated by reference in its entirety, describes using chromophores in photorefractive materials. Chromophores are known in the art and are well described in the literature, such as D. S. Chemla & J. Zyss, “Nonlinear Optical Properties of Organic Molecules and Crystals” (Academic Press, 1987), which is hereby incorporated by reference in its entirety. Also, U.S. Pat. No. 6,090,332, which is hereby incorporated by reference in its entirety, describes fused ring bridge, ring locked chromophores for use in thermally stable photorefractive compositions.

Without being bound to any particular theory, it is believed that chromophores within the chromophore-doped polymer layers can include a dipole moment, such that they provide the superior properties disclosed in this application. In particular, the dipole causes the chromophore(s) to align in response to an applied bias field (or bias voltage). It is believed the aligned chromophores within the chromophore-doped polymer layers form electrostatic interactions with the chromophores within the photorefractive material, thus improving the properties of the photorefractive layer. These electrostatic interactions from the chromophores present in the one or more polymer layers affect the how the chromophores within the photorefractive material respond to a change in applied bias voltage and may result in a reduced grating response and decay time.

Accordingly, in some embodiments, the chromophore has a molecular dipole moment in the range of about 1 debye to about 20 debye. In some embodiments, the chromophore has a molecular dipole moment of at least 5 debye. In some embodiments, the chromophore has a molecular dipole moment of at least 10 debye. In some embodiments, the chromophore has a molecular dipole moment of at least 15 debye.

In some embodiments, the chromophore can be attached to the polymer as a side chain. In some embodiments, when the chromophore is attached to the polymer matrix as a side chain, the chromophore side chain is represented by Structure (0):

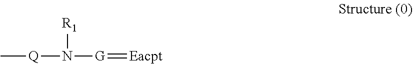

wherein Q represents an alkylene group comprising 1 to 10 carbon atoms with or without a hetero atom such as oxygen or sulfur and preferably Q is an alkylene group represented by (CH₂)ₚ where p is between about 2 and 6. R₁ is selected from the group consisting of a hydrogen atom, a linear alkyl group with up to 10 carbons, a branched alkyl group with up to 10 carbons, and an aromatic group with up to 10 carbons and preferably R₁ is an alkyl group selected from methyl, ethyl, propyl, butyl, pentyl and hexyl. G is a group having a bridge of π-conjugated bond. Eacpt is an electron acceptor group. Preferably Q is selected from the group consisting of ethylene, propylene, butylene, pentylene, hexylene, and heptylene.

In this context, the term “bridge of π-conjugated bond” refers to a molecular fragment that connects two or more chemical groups by a π-conjugated bond. A π-conjugated bond contains covalent bonds between atoms that have σ bonds and π bonds formed between two atoms by overlap of their atomic orbits (s+p hybrid atomic orbits for σ bonds; p atomic orbits for π bonds).

The term “electron acceptor” refers to a group of atoms with a high electron affinity that can be bonded to a t-conjugated bridge. Exemplary acceptors, in order of increasing strength, are: C(O)NR²<C(O)NHR<C(O)NH₂<C(O)OR<C(O)OH<C(O)R<C(O)H<CN<S(O)₂R<NO₂, wherein R and R₂ in these groups are each independently selected from the group consisting of a hydrogen atom, a linear alkyl group with up to 10 carbons, a branched alkyl group with up to 10 carbons, and an aromatic group with up to 10 carbons

The electron acceptor groups may, for example, be the functional groups which are described in U.S. Pat. No. 6,267,913, which is hereby incorporated by reference in its entirety. At least a portion of these electron acceptor groups are shown in the structures below. The symbol “‡” in the chemical structures below specifies an atom of attachment to another chemical group and indicates that the structure is missing a hydrogen that would normally be implied by the structure in the absence of the “‡”:

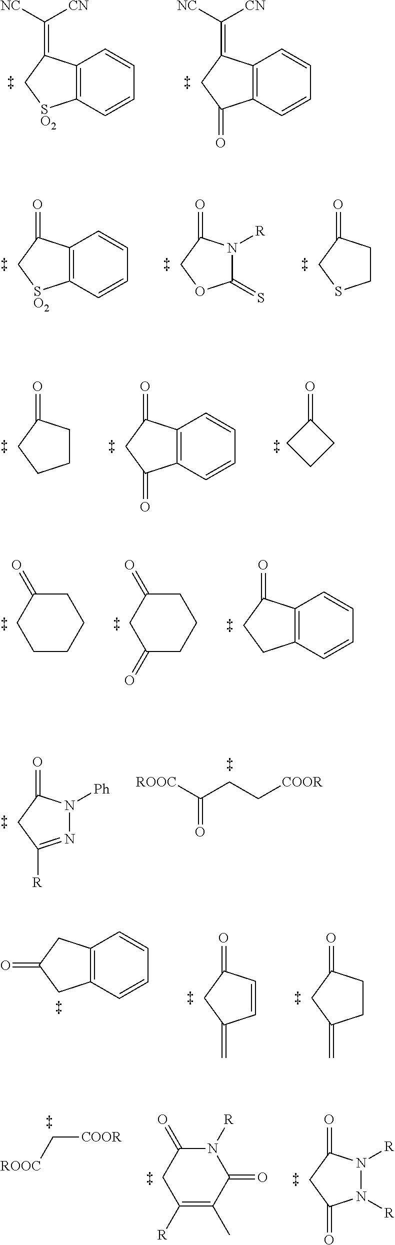

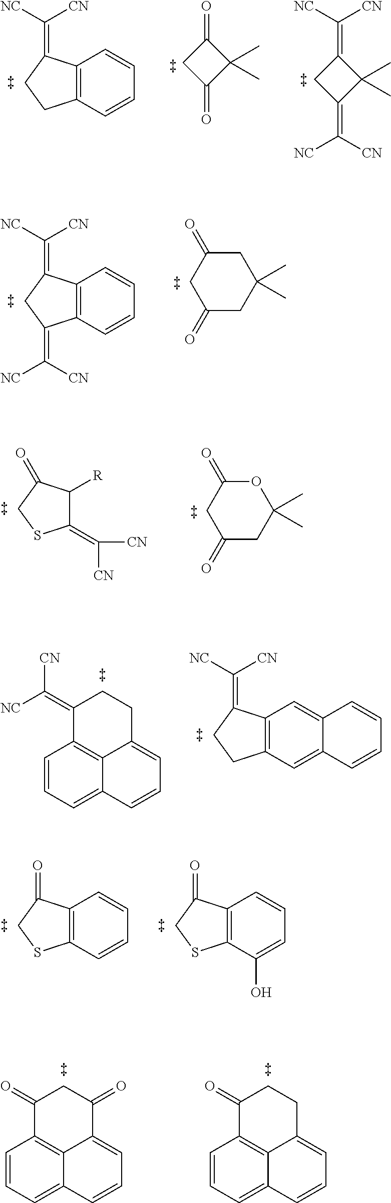

wherein R in the above structures is selected from the group consisting of a hydrogen atom, a linear alkyl group with up to 10 carbons, a branched alkyl group with up to 10 carbons, and an aromatic group with up to 10 carbons.

Most preferably, G in Structure (0) is represented by a structure selected from the group consisting of the Structures (iv) and (v):

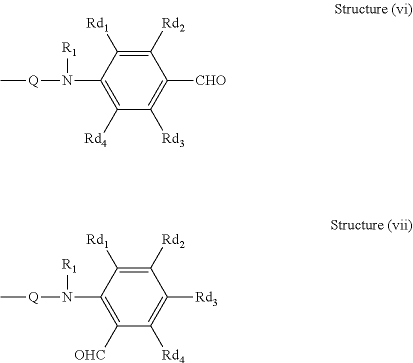

wherein, in both structures (iv) and (v), Rd₁-Rd₄ are each independently selected from the group consisting of a hydrogen atom, a linear alkyl group with up to 10 carbons, a branched alkyl group with up to 10 carbons, and an aromatic group with up to 10 carbons, and preferably Rd₁-Rd₄ are all hydrogen. R₂ is selected from the group consisting of a hydrogen atom, a linear alkyl group with up to 10 carbons, a branched alkyl group with up to 10 carbons, and an aromatic group with up to 10 carbons.

In an embodiment, Eacpt in Structure (0) is ═O or an electron acceptor group represented by a structure selected from the group consisting of the structures:

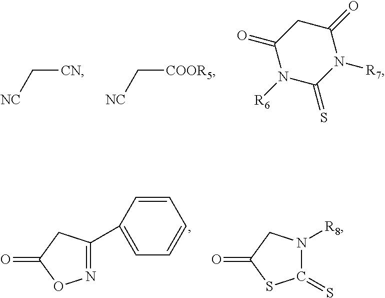

wherein R₅, R₆, R₇ and R₈ are each independently selected from the group consisting of a hydrogen atom, a linear alkyl group with up to 10 carbons, a branched alkyl group with up to 10 carbons, and an aromatic group with up to 10 carbons.

In some embodiment, the one or more chromophores are intermixed with the polymer layer. For example, the chromophore need not be incorporated into the polymer matrix by covalent side chain bonding. In some embodiments, the chromophore is represented by formula (IIb):

D-PiC-A (IIb)

wherein D is an electron donor group; PiC is a π-conjugated group; and A is an electron acceptor group.

The term “electron donor” is defined as a group with low electron affinity when compared to the electron affinity of A. Non-limiting examples of electron donor include amino (NRz₁Rz₂), methyl (CH₃), oxy (ORz₁), phosphino (PRz₁Rz₂), silicate (SiRz₁), and thio (SRz₁), and Rz₁ and Rz₂ are organic substituents independently selected from alkenyls, alkyls, alkynyls, aryls, cycloalkenyls, cycloalkyls, and heteroaryls. In an embodiment, a heteroaryl has at least one heteroatom selected from O and S.

The term “π-conjugated group,” “PiC” in formula (IIb) is independent of the selection of “G” in Structure (0). In some embodiments, suitable π-conjugated groups for PiC include at least one of the following groups: aromatics and condensed aromatics, polyenes, polyynes, quinomethides, and corresponding heteroatom substitutions thereof (e.g. furan, pyridine, pyrrole, and thiophene). In some embodiments, suitable π-conjugated groups for PiC include at least one heteroatom replacement of a carbon in a C═C or C≡C bond and combinations thereof, with or without substitutions. In some embodiments, the suitable π-conjugated groups include no more than two of the preceding groups described in this paragraph. Further, said group or groups may be substituted with a carbocyclic or heterocyclic ring, condensed or appended to the π-conjugated group. Non-limiting examples of π-conjugated groups for PiC in formula (IIb) include:

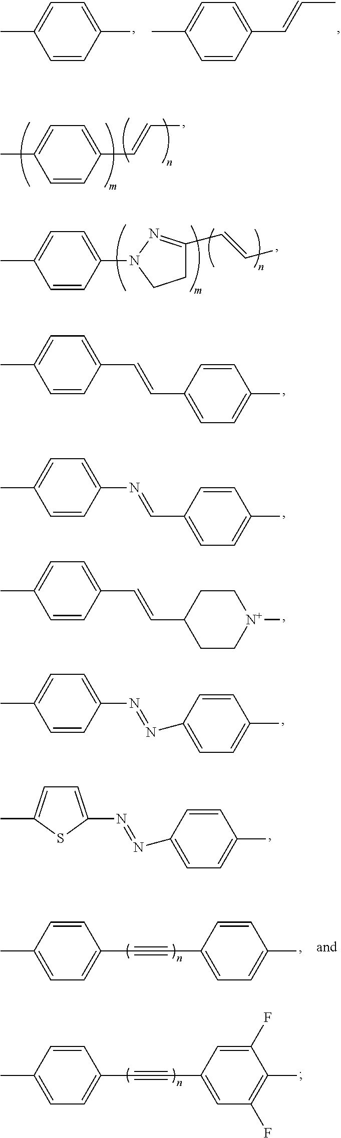

wherein m and n are each independently integers of 2 or less.

The term “electron acceptor” is defined above in formula (IIb) is independent of the selection of “Eacpt” in Structure (0). Additionally, “A” is further defined in this instance as an electron acceptor group with high electron affinity when compared to the electron affinity of D. In some embodiments, A is selected from, but not limited to the following: amide; cyano; ester; formyl; ketone; nitro; nitroso; sulphone; sulphoxide; sulphonate ester; sulphonamide; phosphine oxide; phosphonate; N-pyridinium; hetero-substitutions in B; variants thereof; and other positively charged quaternary salts. In some embodiments, A is selected from the group consisting of: NO₂, CN, C═C(CN)₂, CF₃, F, Cl, Br, I, S(═O)₂CₙF₂ₙ₊₁, S(CₙF₂ₙ₊₁)═NSO₂CF₃; wherein n is an integer from 1 to 10.

Preferably, the chromophore can configure the composition to be sensitive to multiple light wavelengths in the visible spectrum. In some embodiments, the chromophore is represented by formula (III):

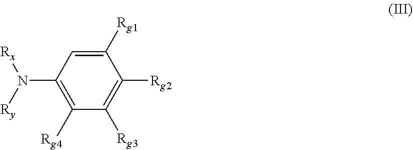

wherein Rₓ and R_{y} in formula (III) together with the nitrogen to which they are attached form a cyclic C₄-C₉ ring or Rₓ and R_{y} in formula (III) are each independently selected from a C₁-C₆ alkyl group or a C₄-C₁₀ aryl group; R_{g1}-R_{g4} in formula (III) are each independently selected from hydrogen or CN; and at least one of R_{g1}-R_{g4} in formula (III) is CN. In an embodiment, at least two of R_{g1}-R_{g4} in formula (III) are CN. In an embodiment, Rₓ and R_{y} in formula (III) together with the nitrogen to which they are attached form a cyclic C₅-C₈ ring.

In some embodiments, the chromophore of formula (III) is represented by formula (IIIa):

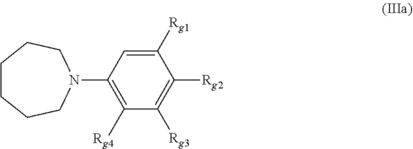

wherein R_{g1}-R_{g4} in formula (IIIa) are each independently selected from hydrogen or CN, and at least one of R_{g1}-R_{g4} in formula (IIIa) is CN. In an embodiment, at least two of R_{g1}-R_{g4} in formula (IIIa) are CN. In an embodiment, the chromophore of formula (IIIa) is selected from one of the following compounds.

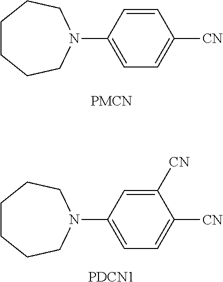

In some embodiments, the chromophore is represented by formula (IV):

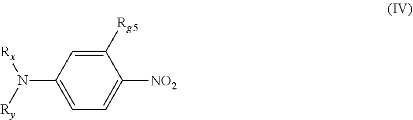

wherein Rₓ and R_{y} in formula (IV) together with the nitrogen to which they are attached form a cyclic C₄-C₉ ring or Rₓ and R_{y} in formula (IV) are each independently selected from a C₁-C₆ alkyl group or a C₄-C₁₀ aryl group; and R_{g5} in formula (IV) is C₁-C₆ alkyl. In an embodiment, Rₓ and R_{y} in formula (IV) together with the nitrogen to which they are attached form a cyclic C₅-C₈ ring.

In some embodiments, the chromophore is represented by formula (V):

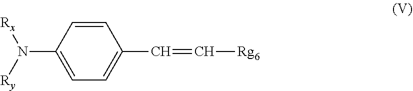

wherein Rₓ and R_{y} in formula (V) together with the nitrogen to which they are attached form a cyclic C₄-C₉ ring or Rₓ and R_{y} in formula (V) are each independently selected from a C₁-C₆ alkyl group or a C₄-C₁₀ aryl group; wherein R_{g6} in formula (V) is selected from CN or COOR, wherein R in formula (V) is hydrogen or a C₁-C₆ alkyl. Both the cis- and trans-isomers of formula (V) can be used. In an embodiment, the chromophore of formula (V) is a cis-isomer. In an embodiment, the chromophore of formula (V) is a trans-isomer. In an embodiment, Rₓ and R_{y} in formula (V) together with the nitrogen to which they are attached form a cyclic C₅-C₈ ring.

In some embodiments, the chromophore of formula (V) is represented by formula (Va):

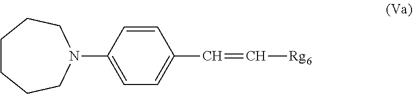

wherein R_{g6} in formula (Va) is selected from CN or COOR, wherein R in formula (Va) is hydrogen or a C₁-C₆ alkyl. Both the cis- and trans-isomers of formula (Va) can be used. In an embodiment, the chromophore of formula (Va) is a cis-isomer. In an embodiment, the chromophore of formula (Va) is a trans-isomer. In an embodiment, the chromophore of formula (Va) is selected from one of the following compounds.

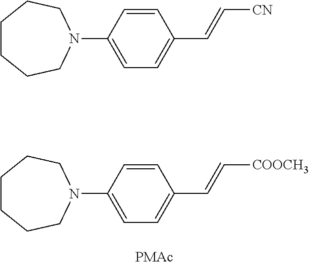 [SMILES: N#C/C=C/c1ccc(N2CCCCCC2)cc1 ; COC(=O)/C=C/c1ccc(N2CCCCCC2)cc1]

In some embodiments, the chromophore is represented by formula (VI):

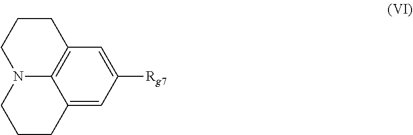

wherein R_{g7} in formula (VI) is selected from CN, CHO, or COOR, wherein R in formula (VI) is hydrogen or a C₁-C₆ alkyl. In an embodiment, the chromophore of formula (VI) is selected from one of the following compounds.

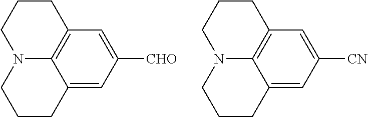 [SMILES: O=Cc1cc2c3c(c1)CCCN3CCC2 ; N#Cc1cc2c3c(c1)CCCN3CCC2]

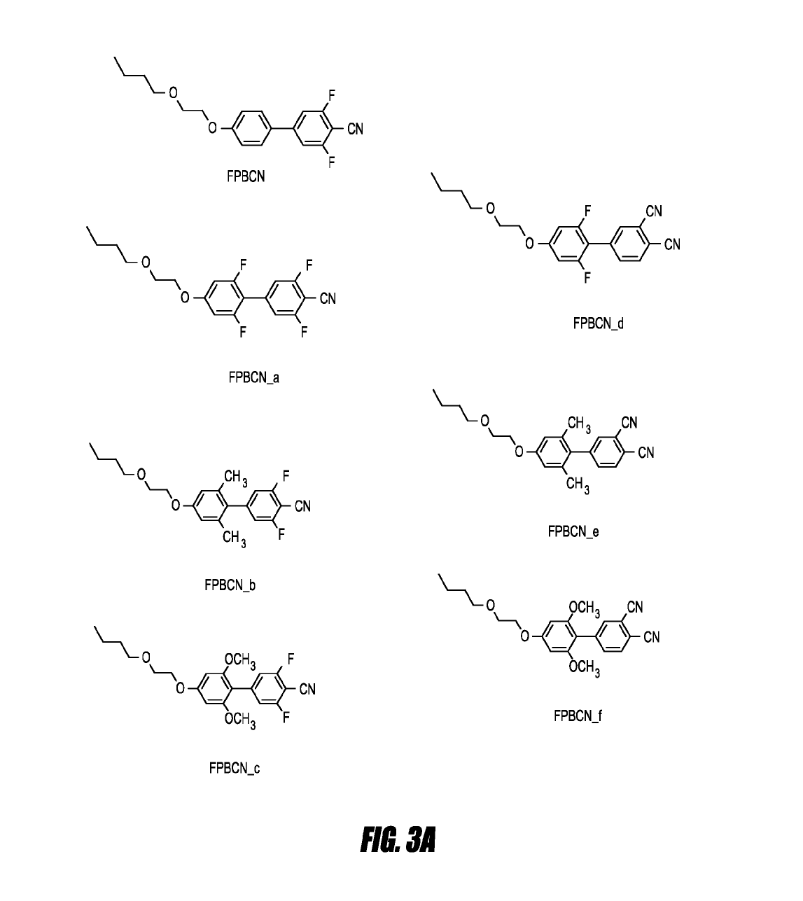

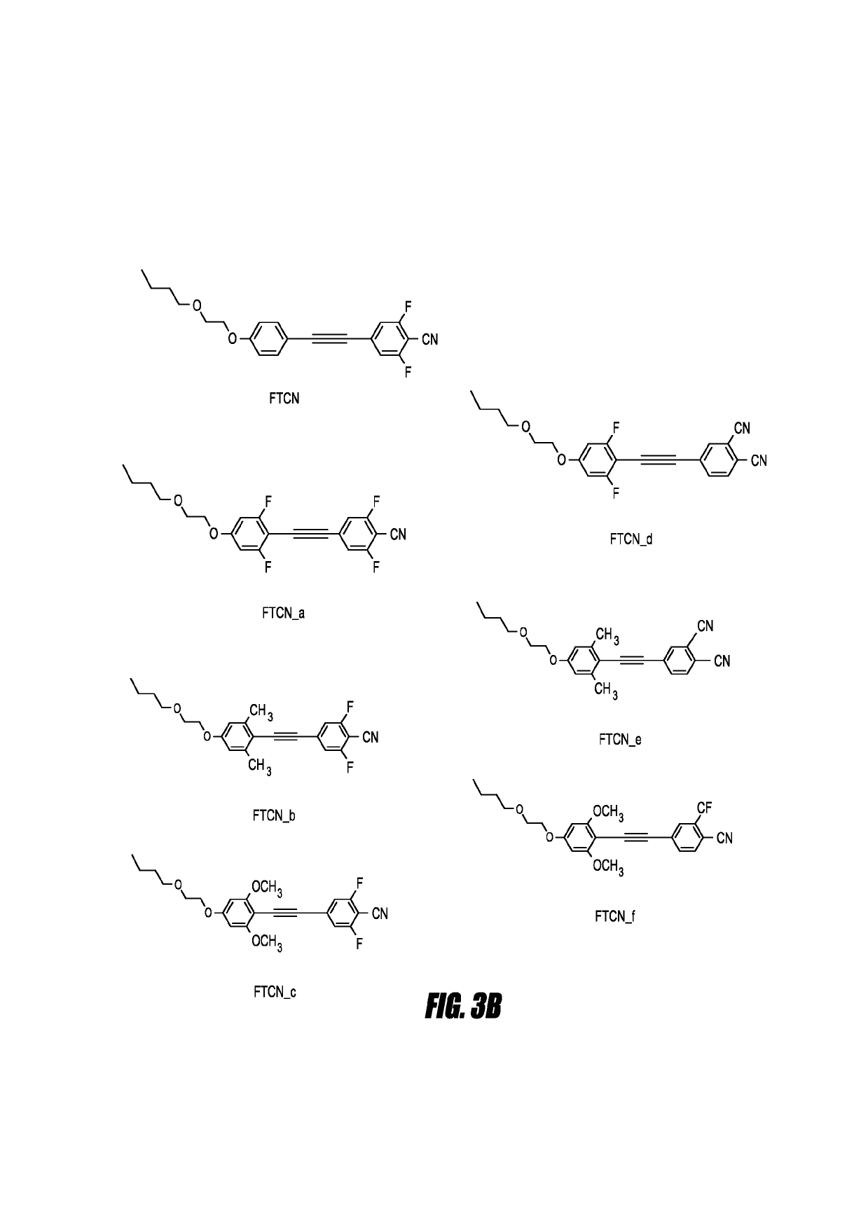

In some embodiments, the chromophore is represented by formula (VII):

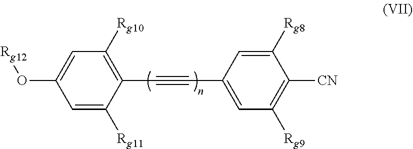

wherein n in formula (VII) is 0 or 1, R_{g8} and R_{g9} in formula (VII) are each independently selected from hydrogen, fluorine or CN, R_{g10} and R_{g11} in formula (VII) are each independently selected from hydrogen, methyl, methoxy, or fluorine, R_{g12} in formula (VII) is a C₁-C₁₀ oxyalkylene group containing 1 to 5 oxygen atoms or a C₁-C₁₀ alkyl group, and at least two of R_{g8}-R_{g12} in formula (VII) are not hydrogen. In an embodiment, at least three of R_{g8}-R_{g12} in formula (VII) are not hydrogen. In an embodiment, at least four of R_{g8}-R_{g12} in formula (VII) are not hydrogen. In an embodiment, R_{g12} in formula (VII) is —CH₂CH₂OCH₂CH₂CH₂CH₃. In an embodiment, the chromophore of formula (VII) is selected from the group of compounds shown in FIGS. 3A and 3B.

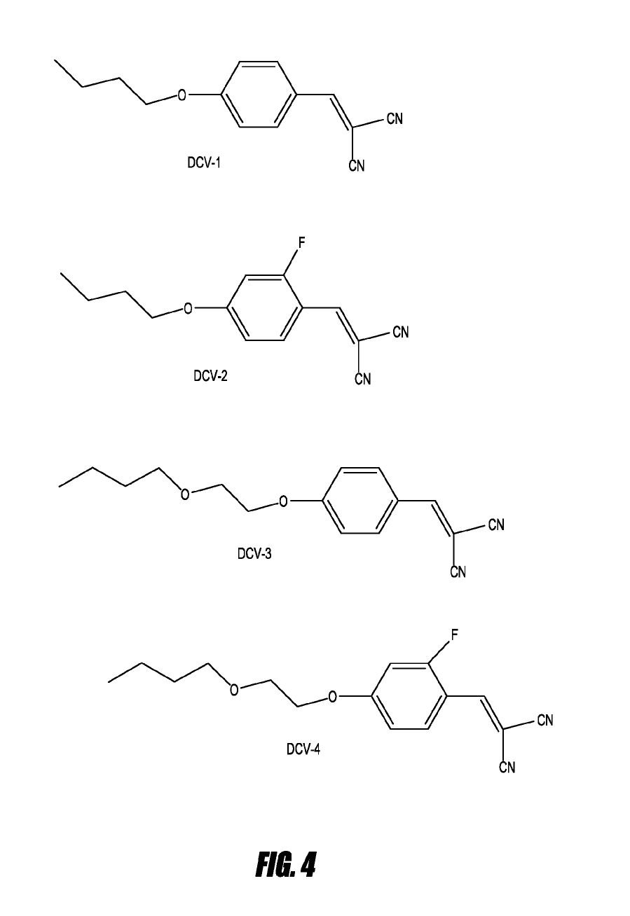

In some embodiments, the chromophore is represented by formula (VIII):

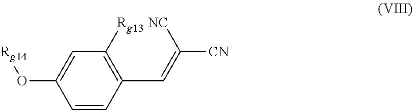

wherein R_{g13} in formula (VIII) is selected from hydrogen or fluorine, and R_{g14} in formula (VIII) is a C₁-C₆ alkyl or a C₁-C₁₀ oxyalkylene group containing 1 to oxygen atoms. In an embodiment, R_{g14} is —CH₂CH₂OCH₂CH₂CH₂CH₃. In an embodiment, R_{g14} is a butyl group. In an embodiment, the chromophore of formula (VIII) is selected from the group of compounds shown in FIG. 4.

In an embodiment, the chromophore is selected from one or more of the following compounds:

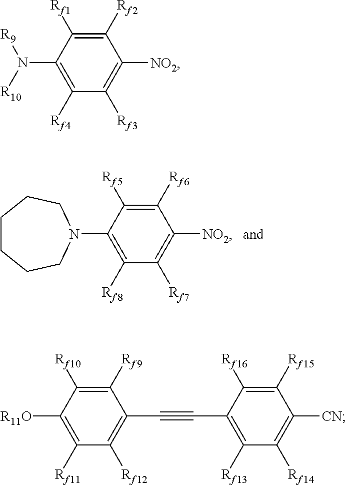

wherein each R₉-R₁₁ in the above compounds is independently selected from the group consisting of hydrogen, C₁-C₁₀ alkyl, and C₄-C₁₀ aryl, wherein the alkyl may be branched or linear, and wherein each Rf₁-Rf₁₆ is independently selected from H, F, and CF₃.

The amount of chromophore in the one or more chromophore-doped polymer layers is not particularly limited and will vary with the type of chromophore and polymer. In some embodiments, the amount of chromophore in the chromophore-doped polymer layer may be about 0.1 to about 15 parts by weight relative to about 100 total parts polymer and chromophore. The chromophore-doped polymer layer may include, for example, at least about 0.3 parts by weight; at least about 0.5 parts by weight; at least about 1.0 parts by weight; or at least about 2 parts by weight relative to about 100 total parts polymer and chromophore. The chromophore-doped polymer layer may also include, for example, no more than about 10 parts by weight; no more than about 9 parts by weight; no more than about 8 parts by weight; no more than about 7 parts by weight; or no more than about 6 parts by weight. Preferably, the amount of chromophore in the chromophore-doped polymer is sufficient to form electrostatic interactions with the chromophores within the photorefractive material.

In one embodiment, the electrode comprises a transparent electrode layer. The transparent electrode layer is further configured as a conducting film. The electrode material comprising the conducting film may be independently selected from the group consisting of metal oxides, metals, and organic films with an optical density of 0.2 or less. Non-limiting examples of electrode layers 104 comprise indium tin oxide (ITO), tin oxide, zinc oxide, gold, aluminum, polythiophene, polyaniline, and combinations thereof. Preferably, the electrodes are independently selected from indium tin oxide and zinc oxide.

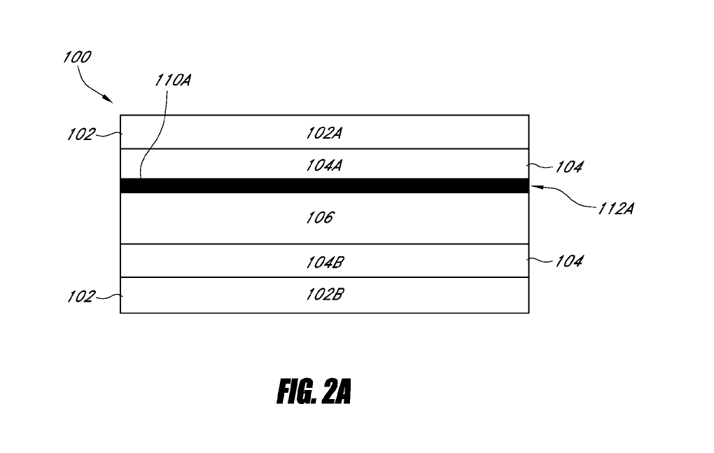

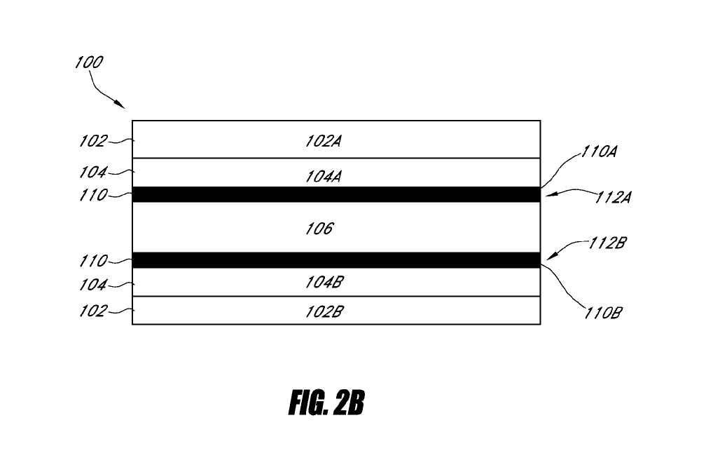

Some embodiments of the photorefractive device 100 are illustrated in FIG. 2A-2B. The photorefractive device 100 comprises a plurality of substrate layers 102, a plurality of electrode layers 104 interposed between the substrate layers 102, a plurality of chromophore-doped polymer layers 110 interposed between the electrode layers 104, and a photorefractive material 106 interposed between the chromophore-doped polymer layers 110.

In one embodiment, a pair of electrode layers 104A, 104B is interposed between a pair of substrate layers 102A, 102B, and the layer of photorefractive material 106 is interposed between the pair of electrode layers 104A, 104B. In an embodiment, illustrated in FIG. 2A, a first chromophore-doped polymer layer 110A is positioned between the first electrode layer 104A and the photorefractive material 106. In an alternative embodiment, illustrated in FIG. 2B, the embodiment of FIG. 2A is modified such that a second chromophore-doped polymer layer 110B is interposed between the second electrode layer 104B and the photorefractive material 106. As discussed above, the first and second polymer layers 110A, 110B can comprise the same material or different materials.

Non-limiting examples of the substrate layers 102 include soda lime glass, silica glass, borosilicate glass, gallium nitride, gallium arsenide, sapphire, quartz glass, polyethylene terephthalate, and polycarbonate. Preferably the substrate layer 102 comprises a material with a refractive index of about 1.5 or less. In some embodiments, the substrate layer exhibits a refractive index of about 1.5 or less.

In some embodiments, the photorefractive material comprises an organic or inorganic polymer exhibiting photorefractive behavior. In an embodiment, the polymer possesses a refractive index of approximately 1.7 or less. In an embodiment, the polymer possesses a refractive index of approximately 1.7. Preferred non-limiting examples include photorefractive materials comprising a polymer matrix with at least one of a repeat unit including a moiety having photoconductive or charge transport ability and a repeat unit including a moiety having non-linear optical ability, as discussed in greater detail below. Optionally, the material may further comprise other components, such as repeat units including another moiety having non-linear optical ability, as well as sensitizers and plasticizers, as described in U.S. Pat. No. 6,610,809, which is hereby incorporated by reference in its entirety. One or both of the photoconductive and non-linear optical components are incorporated as functional groups into the polymer structure, typically as side groups.

The group that provides the charge transport functionality may be any group known in the art to provide such capability. If this group is to be attached to the polymer matrix as a side chain, then the group should be capable of incorporation into a monomer that can be polymerized to form the polymer matrix of the photorefractive composition.

In an embodiment, the photorefractive material comprises photoconductive, or charge transport groups. Non-limiting examples of the photoconductive, or charge transport, groups are illustrated below. In one embodiment, the photoconductive groups comprise phenyl amine derivatives, such as carbazoles and di- and tri-phenyl diamines. In a preferred embodiment, the moiety that provides the photoconductive functionality is chosen from the group of phenyl amine derivates consisting of the following side chain Structures (i), (ii) and (iii):

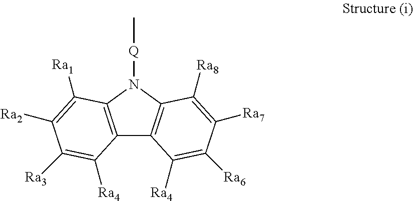

wherein Q represents an alkylene group comprising 1 to 10 carbon atoms with or without a hetero atom and Ra₁-Ra₈ are each independently selected from the group consisting of a hydrogen atom, a linear alkyl group with up to 10 carbons, a branched alkyl group with up to 10 carbons, and an aromatic group with up to 10 carbons;

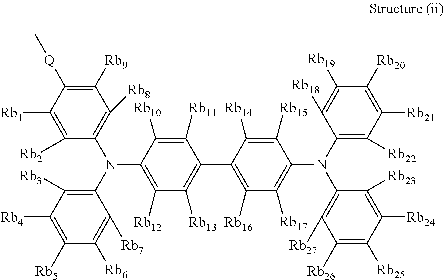

wherein Q represents an alkylene group comprising 1 to 10 carbon atoms with or without a hetero atom and Rb₁-Rb₂₇ are each independently selected from the group consisting of a hydrogen atom, a linear alkyl group with up to 10 carbons, a branched alkyl group with up to 10 carbons, and an aromatic group with up to 10 carbons;

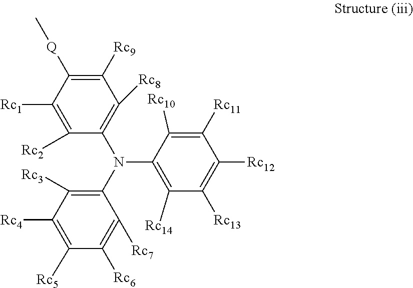

wherein Q represents an alkylene group comprising 1 to 10 carbon atoms with or without a hetero atom and Rc₁-Rc₁₄ are each independently selected from the group consisting of a hydrogen atom, a linear alkyl group with up to 10 carbons, a branched alkyl group with up to 10 carbons, and an aromatic group with up to 10 carbons.

The photorefractive material can also comprise a chromophore. The chromophore, or group that provides the non-linear optical functionality, may be any group known in the art to provide such capability. For example, the chromophore may be any of those discussed above that may be included in the chromophore-doped polymer layer. However, unlike the one or more polymer layers, the photorefractive material includes charge transport moieties to render it photorefractive. The chromophore in the photorefractive layer may be the same or different as the chromophore in the one or more chromophore-doped polymer layers. If the chromophore is to be attached to the polymer matrix as a side chain, then the group, or a precursor of the group, should be capable of incorporation into a monomer that can be polymerized to form the polymer matrix of the composition.

In one embodiment, material backbones, including, but not limited to, polyurethane, epoxy polymers, polystyrene, polyether, polyester, polyamide, polyimide, polysiloxane, and polyacrylate with the appropriate side chains attached, may be used to make the material matrices of the present disclosure.

Preferred types of backbone units are those based on acrylates or styrene. Particularly preferred are acrylate-based monomers, and more preferred are methacrylate monomers. The first polymeric materials to include photoconductive functionality in the polymer itself were the polyvinyl carbazole materials developed at the University of Arizona. However, these polyvinyl carbazole polymers tend to become viscous and sticky when subjected to the heat-processing methods typically used to form the polymer into films or other shapes for use in photorefractive devices.

In contrast, (meth)acrylate-based, and more specifically acrylate-based, polymers, have much better thermal and mechanical properties. That is, they provide better workability during processing by injection-molding or extrusion, for example. This is particularly true when the polymers are prepared by radical polymerization.

The photorefractive material, in an embodiment, is synthesized from a monomer incorporating at least one of the above photoconductive groups or one of the above chromophore groups. It is recognized that a number of physical and chemical properties are also desirable in the polymer matrix. It is preferred that the polymer incorporates both a charge transport group and a chromophore group, so the ability of monomer units to form copolymers is preferred. Physical properties of the formed copolymer that are of importance include, but are not limited to, the molecular weight and the glass transition temperature, T_{g}. Also, it is valuable and desirable, although optional, that the composition should be capable of being formed into films, coatings and shaped bodies of various kinds by standard polymer processing techniques, such as solvent coating, injection molding, and extrusion.

In the present application, the polymer generally has a weight average molecular weight, M_{w}, of from about 3,000 to 500,000, preferably from about 5,000 to 100,000. The term “weight average molecular weight” as used herein means the value determined by the GPC (gel permeation chromatography) method in polystyrene standards, as is well known in the art.

In a non-limiting example, the polymer composition used in the photorefractive material comprises a repeating unit selected from the group consisting of the Structures (i)″, (ii)″, and (iii)″ which provides charge transport functionality:

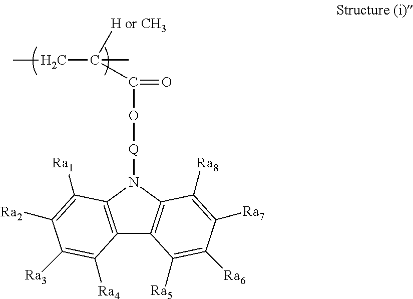

wherein Q represents an alkylene group comprising 1 to 10 carbon atoms with or without a hetero atom and Ra₁-Ra₈ are each independently selected from the group consisting of a hydrogen atom, a linear alkyl group with up to 10 carbons, a branched alkyl group with up to 10 carbons, and an aromatic group with up to 10 carbons;

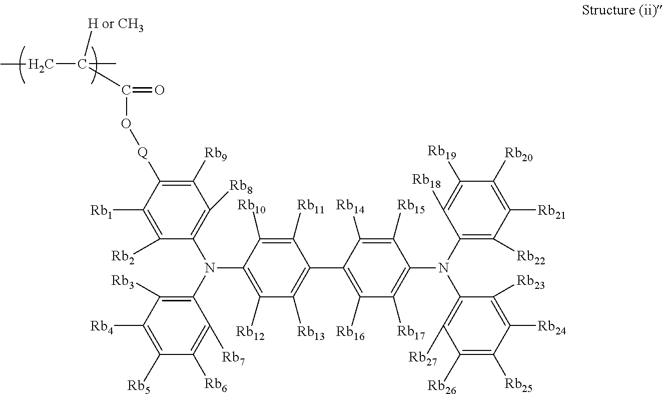

wherein Q represents an alkylene group comprising 1 to 10 carbon atoms with or without a hetero atom and Rb₁-Rb₂₇ are each independently selected from the group consisting of a hydrogen atom, a linear alkyl group with up to 10 carbons, a branched alkyl group with up to 10 carbons, and an aromatic group with up to 10 carbons;

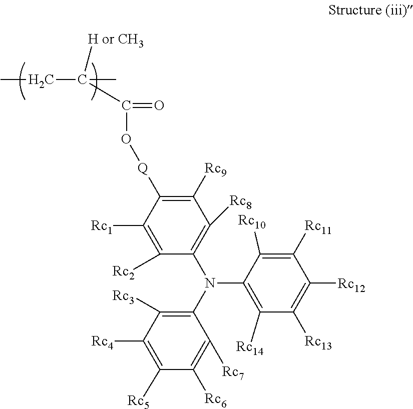

wherein Q represents an alkylene group comprising 1 to 10 carbon atoms with or without a hetero atom and Rc₁-Rc₁₄ are each independently selected from the group consisting of a hydrogen atom, a linear alkyl group with up to 10 carbons, a branched alkyl group with up to 10 carbons, and an aromatic group with up to 10 carbons.

In a non-limiting example, the polymer composition used in the photorefractive material comprises a repeating unit represented by the Structure (0)″ which provides non-linear optical functionality:

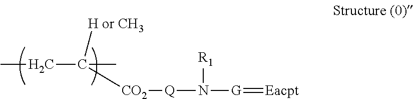

wherein Q represents an alkylene group comprising 1 to 10 carbon atoms with or without a hetero atom such as oxygen or sulfur, and preferably Q is an alkylene group represented by (CH₂)ₚ where p is between about 2 and 6. R₁ is selected from the group consisting of a hydrogen atom, a linear alkyl group with up to 10 carbons, a branched alkyl group with up to 10 carbons, and an aromatic group with up to 10 carbons, and preferably R₁ is an alkyl group selected from methyl, ethyl, propyl, butyl, pentyl and hexyl. G is a group having a bridge of π-conjugated bond. Eacpt is an electron acceptor group. Preferably Q is selected from the group consisting of ethylene, propylene, butylene, pentylene, hexylene, and heptylene. G and Eacpt are as described above with respect to Structure (0).

Further non-limiting examples of monomers including a phenyl amine derivative group as the charge transport component include carbazolylpropyl (meth)acrylate monomer; 4-(N,N-diphenylamino)-phenylpropyl (meth)acrylate; N-[(meth)acroyloxypropylphenyl]-N,N′,N′-triphenyl-(1,1′-biphenyl)-4,4′-diamine; N-[(meth)acroyloxypropylphenyl]-N′-phenyl-N,N′-di(4-methylphenyl)-(1,1′-biphenyl)-4,4′-diamine; and N-[(meth)acroyloxypropylphenyl]-N′-phenyl-N,N′-di(4-buthoxyphenyl)-(1,1′-biphenyl)-4,4′-diamine. Such monomers can be used singly or in mixtures of two or more monomers.

Further non-limiting examples of monomers including a chromophore group as the non-linear optical component include N-ethyl, N-4-dicyanomethylidenyl acrylate and N-ethyl, N-4-dicyanomethylidenyl-3,4,5,6,10-pentahydronaphtylpentyl acrylate.

Diverse polymerization techniques are known in the art to manufacture polymers from the above discussed monomers. One such conventional technique is radical polymerization, which is typically carried out by using an azo-type initiator, such as AIBN (azoisobutyl nitrile). In this radical polymerization method, the polymerization catalysis is generally used in an amount of from about 0.01 to 5 mol %, preferably from about 0.1 to 1 mol %, per mole of the sum of the polymerizable monomers.

In one embodiment, conventional radical polymerization can be carried out in the presence of a solvent, such as ethyl acetate, tetrahydrofuran, butyl acetate, toluene or xylene. The solvent is generally used in an amount of from about 100 to 10000 wt %, and preferably from about 1000 to 5000 wt %, per weight of the sum of the polymerizable monomers.

In an alternative embodiment, conventional radical polymerization is carried out without a solvent in the presence of an inert gas. In one embodiment, the inactive gas comprises one of nitrogen, argon, and helium. The gas pressure during polymerization ranges from about 1 to 50 atm, and preferably from about 1 to 5 atm.

The conventional radical polymerization is preferably carried out at a temperature of from about 50° C. to 100° C. and is allowed to continue for about 1 to 100 hours, depending on the desired final molecular weight and polymerization temperature and taking into account the polymerization rate.

By carrying out the radical polymerization technique based on the teachings and preferences given above, it is possible to prepare polymers having charge transport groups, polymers having non-linear optical groups, and random or block copolymers carrying both charge transport and non-linear optical groups. Polymer systems may further be prepared from combinations of these polymers. Additionally, by following the techniques described herein, it is possible to prepare such materials with exceptionally good properties, such as photoconductivity, response time, and diffraction efficiency.

In some embodiments, the chromophore is not provided in the form of a monomer that polymerizes into a polymer. Rather the chromophore may be dispersed within the photorefractive material. Exemplary composition with the chromophore dispersed within a photorefractive material are disclosed in U.S. Pat. No. 5,064,264, which is hereby incorporated by reference in its entirety. Suitable materials are known in the art and are well described in the literature, such as D. S. Chemla & J. Zyss, “Nonlinear Optical Properties of Organic Molecules and Crystals” (Academic Press, 1987), which is hereby incorporated by reference in its entirety. Also, U.S. Pat. No. 6,090,332, which is hereby incorporated by reference in its entirety, describes fused ring bridge, ring locked chromophores for use in thermally stable photorefractive compositions. Other examples of chromophores are disclosed above with respect to the chromophore-doped polymer layer.

The selected chromophore may be mixed in the matrix copolymer to form a photorefractive material have less than 80 wt % of chromophore, and more preferably less than 40 wt %.

On the other hand, if the polymer is made from monomers that provide only the non-linear optical ability, the photorefractive composition can be made by mixing a component that possesses charge transport properties into the polymer matrix, again as is described in U.S. Pat. No. 5,064,264, which is hereby incorporated by reference in its entirety. Preferred charge transport compounds are good hole transfer compounds, for example, N-alkyl carbazole or triphenylamine derivatives.

As an alternative, or in addition to, adding the charge transport component in the form of a dispersion of entities comprising individual molecules with charge transport capability, a polymer blend can be made of individual polymers with charge transport and non-linear optical abilities. For the charge transport polymer, the polymers already described above, such as those containing phenyl-amine derivative side chains, can be used. Since polymers containing only charge transport groups are comparatively easy to prepare by conventional techniques, the charge transport polymer may be made by radical polymerization or by any other convenient method.

To prepare the non-linear optical containing copolymer, monomers that have side-chain groups possessing non-linear-optical ability may be used. Non-limiting examples of monomers that may be used are those containing the following chemical structures:

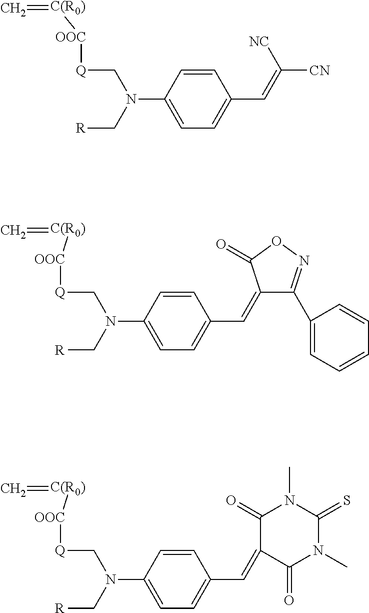

wherein Q represents an alkylene group comprising 1 to 10 carbon atoms with or without a hetero atom such as oxygen or sulfur, and preferably Q is an alkylene group represented by (CH₂)ₚ where p is between about 2 and 6; R₀ is a hydrogen atom or methyl group. R is a linear or branched alkyl group with up to 10 carbons. Preferably R is an alkyl group which is selected from methyl, ethyl, or propyl.

One technique for preparing a copolymer involves the use of a precursor monomer containing a precursor functional group for non-linear optical ability. Typically, this precursor is represented by the following general Structure (1):

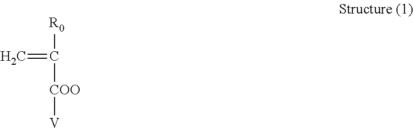

wherein R₀ is a hydrogen atom or methyl group and V is selected from the group consisting of the following structures (vi) and (vii):

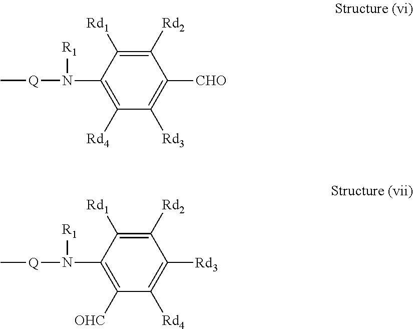

wherein, in both structures (vi) and (vii), Q represents an alkylene group comprising 1 to carbon atoms with or without a hetero atom such as oxygen or sulfur, and preferably Q is an alkylene group represented by (CH₂)ₚ where p is between about 2 and 6. Rd₁-Rd₄ are independently selected from the group consisting of a hydrogen atom, a linear alkyl group with up to 10 carbons, a branched alkyl group with up to 10 carbons, and an aromatic group with up to 10 carbons, and preferably Rd₁-Rd₄ are hydrogen; and wherein R₁ represents a linear or branched alkyl group with up to 10 carbons, and preferably R₁ is an alkyl group selected from methyl, ethyl, propyl, butyl, pentyl or hexyl.

To prepare copolymers, both the non-linear optical monomer and the charge transport monomer, each of which can be selected from the types mentioned above, may be used. The procedure for performing the radical polymerization in this case involves the use of the same polymerization methods and operating conditions, with the same preferences, as described above.

After the precursor copolymer has been formed, it can be converted into the corresponding copolymer having non-linear optical groups and capabilities by a condensation reaction. Typically, the condensation reagent may be selected from the group consisting of:

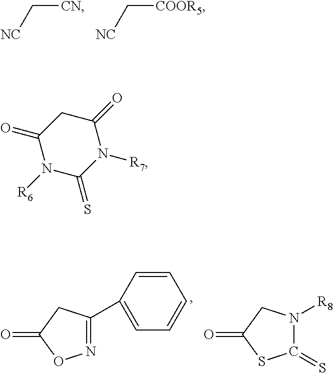

wherein R₅, R₆, R₇ and R₈ are each independently selected from the group consisting of a hydrogen atom, a linear alkyl group with up to 10 carbons, a branched alkyl group with up to 10 carbons, and an aromatic group with up to 10 carbons.

The condensation reaction can be done at room temperature for about 1-100 hrs, in the presence of a pyridine derivative catalyst. A solvent, such as butyl acetate, chloroform, dichloromethylene, toluene or xylene can be used. Optionally, the reaction may be carried out without the catalyst at a solvent reflux temperature of about 30° C. or above for about 1 to 100 hours.

It has been discovered that use of a monomer containing a precursor group for non-linear-optical ability, and conversion of that group after polymerization tends to result in a polymer product of lower polydispersity than the case if a monomer containing the non-linear-optical group is used. This is, therefore, one preferred technique for formation of the photorefractive composition.

There are no restrictions on the ratio of monomer units for the copolymers comprising a repeating unit including the first moiety having charge transport ability, a repeating unit including the second moiety having non-linear-optical ability, and, optionally, a repeating unit including the third moiety having plasticizing ability. However, as a typical representative example, the ratio per 100 weight parts of a (meth)acrylic monomer having charge transport ability relative to a (meth)acrylate monomer having non-linear optical ability ranges between about 1 and 200 weight parts and preferably ranges between about 10 and 100 weight parts. If this ratio is less than about 1 weight part, the charge transport ability of copolymer itself is weak and the response time tends to be too slow to give good photorefractivity. However, even in this case, the addition of already described low molecular weight components having non-linear-optical ability can enhance photorefractivity. On the other hand, if this ratio is more than about 200 weight parts, the non-linear-optical ability of copolymer itself is weak, and the diffraction efficiency tends to be too low to give good photorefractivity. However, even in this case, the addition of already described low molecular weight components having charge transport ability can enhance photorefractivity.

Optionally, other components may be added to the polymer matrix to provide or improve the desired physical properties mentioned earlier in this section. Usually, for good photorefractive capability, it is preferred to add a photosensitizer to serve as a charge generator. A wide choice of such photosensitizers is known in the art. One suitable sensitizer includes a fullerene. “Fullerenes” are carbon molecules in the form of a hollow sphere, ellipsoid, tube, or plane, and derivatives thereof. One example of a spherical fullerene is C₆₀. While fullerenes are typically comprised entirely of carbon molecules, fullerenes may also be fullerene derivatives that contain other atoms, e.g., one or more substituents attached to the fullerene. In an embodiment, the sensitizer is a fullerene selected from C₆₀, C₇₀, C₈₄, each of which may optionally be substituted. In an embodiment, the fullerene is selected from soluble C₆₀ derivative [6,6]-phenyl-C61-butyricacid-methylester, soluble C₇₀ derivative [6,6]-phenyl-C₇₁-butyricacid-methylester, or soluble C₈₄ derivative [6,6]-phenyl-C₈₅-butyricacid-methylester. Fullerenes can also be in the form of carbon nanotubes, either single-wall or multi-wall. The single-wall or multi-wall carbon nanotubes can be optionally substituted with one or more substituents. Another suitable sensitizer includes a nitro-substituted fluorenone. Non-limiting examples of nitro-substituted fluorenones include nitrofluorenone, 2,4-dinitrofluorenone, 2,4,7-trinitrofluorenone, and (2,4,7-trinitro-9-fluorenylidene)malonitrile. Fullerene and fluorenone are non-limiting examples of photosensitizers that may be used. The amount of photosensitizer required is usually less than about 3 wt %.

The compositions can also be mixed with one or more components that possess plasticizer properties into the polymer matrix to form the photorefractive composition. Any commercial plasticizer compound can be used, such as phthalate derivatives or low molecular weight hole transfer compounds, for example N-alkyl carbazole or triphenylamine derivatives or acetyl carbazole or triphenylamine derivatives. N-alkyl carbazole or triphenylamine derivatives containing electron acceptor group, depicted in the following structures 4, 5, or 6, can help the photorefractive composition more stable, since the plasticizer contains both N-alkyl carbazole or triphenylamine moiety and non-liner optics moiety in one compound.

Non-limiting examples of the plasticizer include ethyl carbazole; 4-(N,N-diphenylamino)-phenylpropyl acetate; 4-(N,N-diphenylamino)-phenylmethyloxy acetate; N-(acetoxypropylphenyl)-N,N′,N′-triphenyl-(1,1′-biphenyl)-4,4′-diamine; N-(acetoxypropylphenyl)-N′-phenyl-N,N′-di(4-methylphenyl)-(1,1′-biphenyl)-4,4′-diamine; and N-(acetoxypropylphenyl)-N′-phenyl-N,N′-di(4-buthoxyphenyl)-(1,1′-biphenyl)-4,4′-diamine. Such compounds can be used singly or in mixtures of two or more monomers. Also, un-polymerized monomers can be low molecular weight hole transfer compounds, for example 4-(N,N-diphenylamino)-phenylpropyl (meth)acrylate; N-[(meth)acroyloxypropylphenyl]-N,N′,N′-triphenyl-(1,1′-biphenyl)-4,4′-diamine; N-[(meth)acroyloxypropylphenyl]-N′-phenyl-N,N′-di(4-methylphenyl)-(1,1′-biphenyl)-4,4′-diamine; and N-[(meth)acroyloxypropylphenyl]-N′-phenyl-N,N′-di(4-buthoxyphenyl)-(1,1′-biphenyl)-4,4′-diamine. Such plasticizers can be used singly or in mixtures of two or more monomers.

Preferably, as another type of plasticizer, N-alkyl carbazole or triphenylamine derivatives, which contains electron acceptor group, as depicted in the following Structures 4, 5, or 6, can be used:

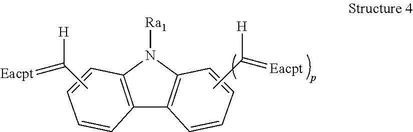

wherein Ra₁ is independently selected from the group consisting of a hydrogen atom, a linear alkyl group with up to 10 carbons, a branched alkyl group with up to 10 carbons, and an aromatic group with up to 10 carbons; p is 0 or 1;

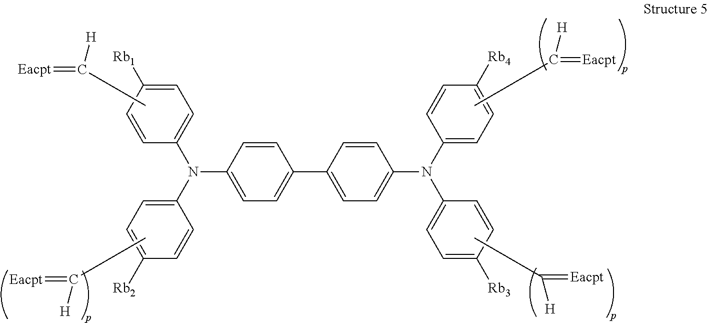

wherein Rb₁-Rb₄ are each independently selected from the group consisting of a hydrogen atom, a linear alkyl group with up to 10 carbons, a branched alkyl group with up to 10 carbons, and an aromatic group with up to 10 carbons; p is 0 or 1;

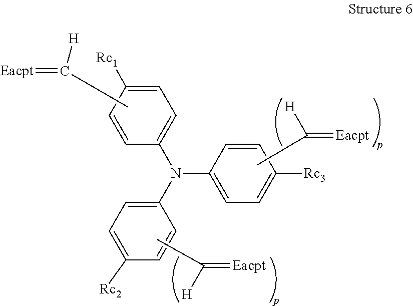

wherein Rc₁-Rc₃ are each independently selected from the group consisting of a hydrogen atom, a linear alkyl group with up to 10 carbons, a branched alkyl group with up to 10 carbons, and an aromatic group with up to 10 carbons; p is 0 or 1; wherein Eacpt is ═O or an electron acceptor group and represented by a structure selected from the group consisting of the structures:

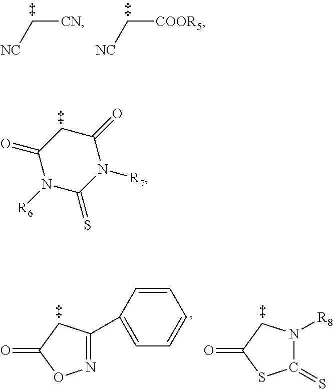

wherein R₅, R₆, R₇ and R₈ are each independently selected from the group consisting of a hydrogen atom, a linear alkyl group with up to 10 carbons, a branched alkyl group with up to 10 carbons, and an aromatic group with up to 10 carbons.

Preferred embodiments include polymers of comparatively low T_{g} when compared with similar polymers prepared in accordance with conventional methods. The inventors have recognized that this provides a benefit in terms of lower dependence on plasticizers. By selecting copolymers of intrinsically moderate T_{g} and by using methods that tend to depress the average T_{g}, it is possible to limit the amount of plasticizer required for the composition to preferably no more than about 30% or 25%, and more preferably lower, such as no more than about 20%.

### EXAMPLES

It has been discovered that photorefractive devices produced using the systems and methods disclosed above can achieve a reduction in grating decay time, for example, of 50% to 96% to that of photorefractive devices having polymer layers that not doped with chromophores.

These benefits are further described by the following examples, which are intended to be illustrative of the embodiments of the disclosure, but are not intended to limit the scope or underlying principles in any way.

### (a) Synthesis of Non-Linear-Optical Chromophore 7-FDCST

The non-linear-optical precursor, 4-homopiperidino-2-fluorobenzylidene malononitrile, (“7-FDCST”) was synthesized according to the following two-step synthesis scheme:

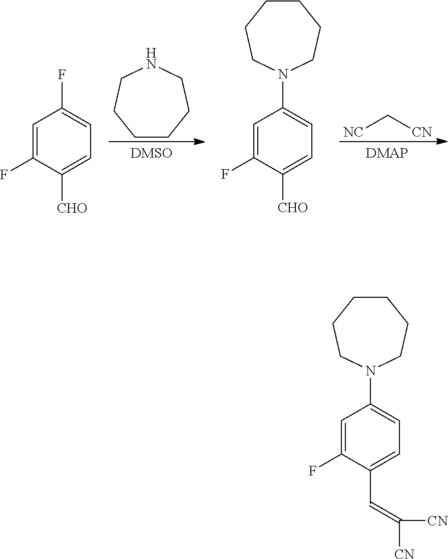

A mixture of 2,4-difluorobenzaldehyde (25 g or 176 mmol), homopiperidine (17.4 g or 176 mmol), lithium carbonate (65 g or 880 mmol), and DMSO (625 mL) was stirred at 50° C. for 16 hours. Water (50 mL) was added to the reaction mixture. The products were extracted with ether (100 mL). After removal of ether, the crude products were purified by silica gel column chromatography using hexanes-ethyl acetate (9:1) as an eluent and crude intermediate was obtained (22.6 g,). 4-(Dimethylamino)pyridine (230 mg) was added to a solution of the 4-homopiperidino-2-fluorobenzaldehyde (22.6 g or 102 mmol) and malononitrile (10.1 g or 153 mmol) in methanol (323 mL). The reaction mixture was kept at room temperature and the product was collected by filtration and purified by recrystallization from ethanol. The final product yield was 18.1 g (38%).

### (b) Synthesis of Non-Linear Optical Chromophore 1-Hexamethyleneimine-4-Nitrobenzene

The non-linear-optical, chromophore 1-hexamethyleneimine-4-nitrobenzene (“PNO2”) was synthesized according to the following synthesis scheme:

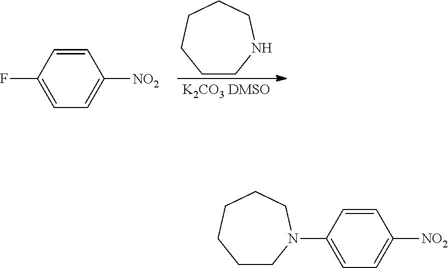

A mixture of 4-fluorobenzaldehyde (3 g, 21.26 mmol), homopiperidine (2.11 g, 21.26 mmol), lithium carbonate (3.53 g, 25.51 mmol), and DMSO (40 mL) was stirred at 50° C. for 16 hours. Water (50 mL) was added to the reaction mixture. The products were extracted with ether (100 mL). After removal of ether, the crude products were recrystallized and yellow crystal was obtained. The compound yield was 4.45 g (95%).

### (c) Synthesis of Non-Linear Optical Chromophore Methyl 3-(4-(Azepan-1-Yl)Phenyl)Acrylate

The non-linear-optical chromophore methyl 3-(4-(azepan-1-yl)phenyl)acrylate (“PMAc”) was synthesized according to the following synthesis scheme:

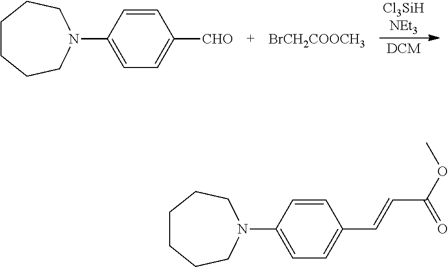

In a 250 mL two-neck flask, anhydrous methylene chloride (60 mL) and 4-(azepan-1-yl)benzaldehyde (4.06 g, 20 mmol) were added. Then, methyl 2-bromoacetate (7.04 g, 46 mmol) followed by triethylamine (10.1 g, 100 mmol) and trichlorosilane (5.41 g, 40 mmol) were added at −10° C. under nitrogen atmosphere. The mixture was stirred at −10° C. for 8 hours and then gradually warmed to room temperature overnight. The reaction mixture was quenched by saturated NaHCO₃ aqueous solution and water. The products were extracted with ether and washed by brine and dried over MgSO₄. The crude products were purified by column. The compound yield was 2.48 g (48%).

### (d) Preparation of Chromophore-containing Polymer Solution

The chromophore-containing polymer solution was prepared by dissolving about 10% to about 45% polymer (APC, PMMA, Sol-gel or polyimide) powder by weight in cyclopentanone. The polymer solution was stirred under ambient conditions for at least 12 hours to ensure substantially total dissolution, and then filtered using an approximately 0.2 μm PTFE filter. About 0.5% to about 15% by weight of the chromophore (e.g., 7-FDCST, PNO2, PMAc, etc.) was subsequently added to the polymer mixture and stirred for about 30 min.

### (e) Preparation of Chromophore-Doped Polymer Layer

The resulting mixture was applied to a transparent electrode layer composed of ITO by spin-coating or solvent casting. Solvent components were removed from the applied mixture by heat treatment up to 100° C. at a predetermined heating program for about 6 hours. The applied mixture was further subjected to vacuum heating at about 130° C. for about 1 hour to form an about 0.5 μm to an about 50 μm thick carbon chromophore-doped polymer layer on the electrode.

### (f) Monomers Containing Charge Transport Groups—TPD Acrylate Monomer:

Triphenyl diamine type (N-[acroyloxypropylphenyl]-N,N′,N′-triphenyl-(1,1′-biphenyl)-4,4′-diamine) (TPD acrylate) were purchased from Wako Chemical, Japan. The TPD acrylate type monomers have the structure:

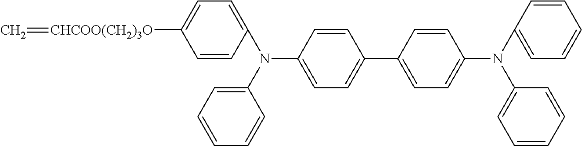

### (g) Monomers Containing Non-Linear-Optical Groups

The non-linear-optical precursor monomer 5-[N-ethyl-N-4-formylphenyl]amino-pentyl acrylate was synthesized according to the following synthesis scheme:

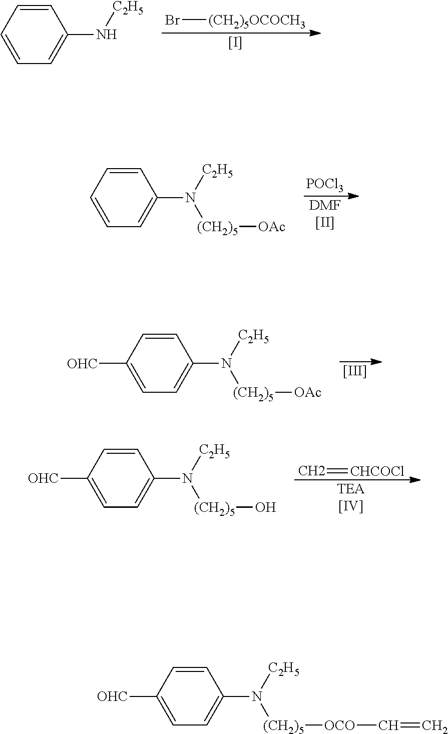

### Step I:

In a solution of bromopentyl acetate (about 5 mL or 30 mmol) and toluene (about 25 mL), triethylamine (about 4.2 mL or 30 mmol) and N-ethylaniline (about 4 mL or 30 mmol) were added at about room temperature. This solution was heated to about 120° C. overnight. After cooling down, the reaction mixture was rotary-evaporated. The residue was purified by silica gel chromatography (developing solvent: hexane/acetone=about 9/1). An oily amine compound was obtained. (Yield: about 6.0 g (80%))

### Step II:

Anhydrous DMF (about 6 mL or 77.5 mmol) was cooled in an ice-bath. Then, POCl₃ (about 2.3 mL or 24.5 mmol) was added dropwise into a roughly 25 mL flask, and the mixture was allowed to come to room temperature. The amine compound (about 5.8 g or 23.3 mmol) was added through a rubber septum by syringe with dichloroethane. After stirring for about 30 min., this reaction mixture was heated to about 90° C. and the reaction was allowed to proceed overnight under an argon atmosphere.

After the overnight reaction, the reaction mixture was cooled, and poured into brine water and extracted by ether. The ether layer was washed with potassium carbonate solution and dried over anhydrous magnesium sulfate. After removing the magnesium sulfate, the solvent was removed and the residue was purified by silica gel chromatography (developing solvent: hexane/ethyl acetate=about 3/1). An aldehyde compound was obtained. (Yield: about 4.2 g (65%))

### Step III:

The aldehyde compound (about 3.92 g or 14.1 mmol) was dissolved with methanol (about 20 mL). Into this mixture, potassium carbonate (about 400 mg) and water (about 1 mL) were added at room temperature and the solution was stirred overnight. The next day, the solution was poured into brine water and extracted by ether. The ether layer was dried over anhydrous magnesium sulfate. After removing the magnesium sulfate, the solvent was removed and the residue was purified by silica gel chromatography (developing solvent: hexane/acetone=about 1/1). An aldehyde alcohol compound was obtained. (Yield: about 3.2 g (96%))

### Step IV:

The aldehyde alcohol (about 5.8 g or 24.7 mmol) was dissolved with anhydrous THF (about 60 mL). Into the solution, triethylamine (about 3.8 mL or 27.1 mmol) was added and the solution was cooled by ice-bath. Acrolyl chloride (about 2.1 mL or 26.5 mmol) was added and the solution was maintained at 0° C. for 20 minutes. Thereafter, the solution was allowed to warm up to room temperature and stirred at room temperature for 1 hour, at which point TLC indicated that all of the alcohol compound had disappeared. The solution was poured into brine water and extracted by ether. The ether layer was dried over anhydrous magnesium sulfate. After removing the magnesium sulfate, the solvent was removed and the residue acrylate compound was purified by silica gel chromatography (developing solvent: hexane/acetone=about 1/1). The compound yield was about 5.38 g (76%), and the compound purity was about 99% (by GC).

### (h) Synthesis of Matrix Polymer for Use in the Photorefractive Material

A charge transport monomer N-[(meth)acroyloxypropylphenyl]-N,N′, N′-triphenyl-(1,1′-biphenyl)-4,4′-diamine (TPD acrylate) (43.34 g), and a non-linear-optical precursor monomer 5-[N-ethyl-N-4-formylphenyl]amino-pentyl acrylate (4.35 g), prepared as described above, were introduced into a three-necked flask. After toluene (400 mL) was added and purged by argon gas for 1 hour, azoisobutylnitrile (118 mg) was added into this solution. Then, the solution was heated to 65° C., while continuing to purge with argon gas.

After about 18 hours of polymerization, the polymer solution was diluted with toluene. The polymer was precipitated from the solution and added to methanol, and the resulting polymer precipitate was collected and washed in diethyl ether and methanol. The white polymer powder was collected and dried. The yield of polymer was about 66%.

The weight average and number average molecular weights were measured by gel permeation chromatography, using polystyrene standard. The results were Mₙ=about 10,600, M_{w}=about 17,100, giving a polydispersity of about 1.61.

To form the polymer with non-linear-optical capability, the precipitated precursor polymer (5.0 g) was dissolved with chloroform (24 mL). Into this solution, dicyanomalonate (1.0 g) and dimethylaminopyridine (40 mg) were added, and the reaction was allowed to proceed overnight at 40° C. As before, the polymer was recovered from the solution by filtration of impurities, followed by precipitation into methanol, washing and drying.

(i) Plasticizer

N-ethylcarbazole is commercially available from Aldrich and was used after recrystallization.

### (j) Preparation of Photorefractive Material

The photorefractive material was prepared with following components:

| | | |
|---|---|---|
| (i) | Matrix polymer (described above): | 50 wt % |
| (ii) | Prepared chromophore of 7-FDCST | 30 wt % |
| (iii) | Ethyl carbazole plasticizer | 20 wt % |

To prepare the photorefractive composition, the components listed above were dissolved with toluene and stirred overnight at room temperature. After removing the solvent by rotary evaporator and vacuum pump, the residue was gathered. This residue mixture—which is used to form the photorefractive material—was put on a slide glass and melted at about 125° C. to make an approximately 200-300 μm thickness film, or pre-cake.

### Example 1

### Preparation of Photorefractive Devices

A photorefractive device was prepared having generally the same structure and components as shown in FIG. 2B: two ITO-coated glass substrates (electrode and substrate), two chromophore-doped polymer layers, and a photorefractive material. The photorefractive device was fabricated using the following steps:

(i) Polymer Solution: About 20% by weight of APC (amorphous polycarbonate) powder was dissolved in cyclopentonone

(ii) Chromophore-doped Solution: 7-FDCST was intermixed with the polymer solution at a weight ratio of about 5 parts 7-FDCST relative to about 95 parts APC, i.e., 100 parts total of chromophore and polymer.

(iii) Forming Chromophore-doped Polymer Layer: The chromophore-doped polymer solution was applied by spin coating onto the ITO film and dried at up to 100° C. for about 6 hours using a predetermined heating program. The applied solution was further subjected to vacuum heating at 130° C. for about 1 hour. These steps provided an about 12 μm thick chromophore-doped polymer layer.

(iv) Assembling the Photorefractive Device: The photorefractive film or pre-cake was transferred from the glass plate and interposed between the two chromophore-doped polymer layers to form a photorefractive device as shown in FIG. 2B. The total combined thickness for the polymer layers was about 24 μm and the photorefractive material was about 104 μm thick.

### Example 2

A photorefractive device was obtained in the same manner as in Example 1 except that it only contains one 7-FDCST chromophore-doped APC polymer layer with a thickness of 12 μm, rather than two. As such, the total polymer thickness was 12 μm.

### Example 3

A photorefractive device was obtained in the same manner as in Example 2 except that the weight ratio of 7-FDCST to APC in the polymer layer was about 0.5:99.5. As such, the chromophore made up 0.5% of the chromophore-doped polymer layer instead of 5%.

### Example 4

A photorefractive device was obtained in the same manner as in Example 1 except that each of the polymer layers was about 13 μm thick. Thus, the combined total thickness of the polymer layers was about 26 μm. Additionally, the weight ratio of 7-FDCST to APC in the polymer layer was about 0.5:99.5. As such, the chromophore made up 0.5% of the chromophore-doped polymer layer instead of 5%.

### Example 5

A photorefractive device was obtained in the same manner as in Example 1 except that each of the polymer layers was about 13 μm thick. Thus, the combined total thickness of the polymer layers was about 26 μm. The percentage of chromophore in the polymer layer remained at 5%.

### Example 6

A photorefractive device was obtained in the same manner as in Example 1 except that each of the polymer layer thicknesses was about 15 μm thick. Thus, the combined total thickness of the polymer layers was about 30 μm.

### Example 7

A photorefractive device was obtained in the same manner as in Example 4 except that each of the polymer layers was about 20 μm thick. Thus, the combined total thickness of the polymer layers was about 40 μm. The weight ratio of 7-FDCST to APC in the polymer layer was about 0.5:99.5.

### Example 8

A photorefractive device was obtained in the same manner as in Example 1 except that each of the polymer layers was about 20 μm. Thus, the combined total thickness of the polymer layers was about 40 μm.

### Comparative Example 1

A photorefractive device was obtained in the same manner as in the Example 1 except that each of the polymer layers was about 8 μm. Thus, the combined total thickness of the polymer layers was about 16 μm. The polymer layers were not doped with chromophore, and therefore did not include the 7-FDCST chromophore.

### Comparative Example 2

A photorefractive device was obtained in the same manner as in the Comparative Example 1 except that it only contains a single polymer layer which was about 10 μm thick. The polymer layer did not include the 7-FDCST chromophore.

### Comparative Example 3

A photorefractive device was obtained in the same manner as in the Comparative Example 1 except that each of the polymer layers was about 15 μm thick. Thus, the total combined thickness of the polymer layers was about 30 μm. The polymer layers did not include the 7-FDCST chromophore.

### Comparative Example 4

A photorefractive device was obtained in the same manner as in the Comparative Example 2 except that the single polymer layer was about 20 μm thick. The polymer layer did not include the 7-FDCST chromophore.

### Comparative Example 5

A photorefractive device was obtained in the same manner as in the Comparative Example 1 except that each of the polymer layers was about 20 μm. Thus, the total combined thickness of the polymer layers was about 40 μm. The polymer layers did not include the 7-FDCST chromophore.

### Measurement of Diffraction Efficiency

The diffraction efficiency was measured as a function of the applied field, by four-wave mixing experiments at about 532 nm with two s-polarized writing beams and a p-polarized probe beam. The angle between the bisector of the two writing beams and the sample normal was about 60 degrees and the angle between the writing beams was adjusted to provide an approximately 2.5 μm grating spacing in the material (about 20 degrees). The writing beams had approximately equal optical powers of about 0.45 mW/cm² after correction for reflection losses—which correlates with a total optical power of about 1.5 mW. The beams were collimated to a spot size of approximately 500 μm. The optical power of the probe was about 100 μW.

The measurement of a diffraction efficiency peak bias was performed as followings: The electric field (V/μm) applied to the photorefractive device sample was varied from 0 V/μm all the way up to 100 V/μm with a certain time period (typically 30 s), and the sample was illuminated with the two writing beams and the probe beam during the certain time period. Then, the diffracted beam was recorded. According to the theory,

$$η ∼ {sin}^{2} ( k \frac{{E}_{o} {E}_{o}^{G}}{\sqrt{1 + {( {E}_{o}^{G} / {E}_{q} )}^{2}}} )$$

where E₀^{G} is the component of E₀ along the direction of the grating wave-vector and E_{q} is the trap limited saturation space-charge field. The diffraction efficiency will show maximum peak value at the predetermined applied bias. The peak diffraction efficiency bias thus is a very useful parameter to determine the device.

### Measurement of Rising Time (Response Time) and Down Time (Decay Time)

The response time and decay time were measured as a function of the applied field, using a procedure essentially the same as that described in the diffraction efficiency measurement: four-wave mixing experiments at 532 nm with s-polarized writing beams and a p-polarized probe beam. The angle between the bisector of the two writing beams and the sample normal was 60 degrees and the angle between the writing beams was adjusted to provide a 2.5 μm grating spacing in the material (about 20 degrees). The writing beams had equal optical powers of 0.45 mW/cm² after correction for reflection losses—which correlates with a total optical power of about 1.5 mW. The beams were collimated to a spot size of approximately 500 μm. The optical power of the probe was 100 μW.

The measurement of the grating buildup time was done as follows: an electric field (V/μm) was applied to the sample corresponding to slightly below the bias peak voltage (e.g., about 0.1-0.2 kV below the bias peak voltage), and the sample was illuminated with two writing beams and the probe beam. Then, the evolution of the diffracted beam was recorded. The response time (rising time) and down time (decaying time) were estimated as the time required for reaching e⁻¹ of steady-state diffraction efficiency.

The performance of each device is summarized as follows in Table 1.

TABLE 1
Grating Response Time, Decay Time, and Bias
Peak Voltage of Photorefractive Device

| | Individual | Total | Grating | Grating | |
|---|---|---|---|---|---|
| | Polymer | Thickness | Response | Decay | |
| | Layer | of Polymer | Time | Time | Bias Peak |
| Example | Thickness | Layers | (Second) | (Second) | (kV) |
| Example 1 | 12 μm | 24 μm | 16 s | 130 s | 2.5 |
| (+5% 7-FDCST | | | at 2.4 kV | at 2.4 kV | |
| Chromophore) | | | | | |
| Example 2 | 12 μm | 12 μm | 11 s | 44 s | 1.7 |
| (+5% 7-FDCST | | | at 1.6 kV | at 1.6 kV | |
| Chromophore) | | | | | |
| Example 3 | 12 μm | 12 μm | 25 s | 14 s | 2.2 |
| (+0.5% 7-FDCST | | | at 2.0 kV | at 2.0 kV | |
| Chromophore) | | | | | |
| Example 4 | 13 μm | 26 μm | 20 s | 50 s | 2.7 |
| (+0.5% 7-FDCST | | | at 2.5 kV | at 2.5 kV | |
| Chromophore) | | | | | |
| Example 5 | 13 μm | 26 μm | 12 s | 30 s | 2.1 |
| (+5% 7-FDCST | | | at 2.0 kV | at 2.0 kV | |
| Chromophore) | | | | | |
| Example 6 | 15 μm | 30 μm | 4 s | 20 s | 3.0 |
| (+5% 7-FDCST | | | at 3.0 kV | at 3.0 kV | |
| Chromophore) | | | | | |
| Example 7 | 20 μm | 40 μm | 26 s | 350 s | 4.2 |
| (+0.5% 7-FDCST | | | at 3.8 kV | at 3.0 kV | |
| Chromophore) | | | | | |
| Example 8 | 20 μm | 40 μm | 17 s | 44 s | 2.6 |
| (+5% 7-FDCST | | | at 2.5 kV | at 2.5 kV | |
| Chromophore) | | | | | |
| Comparative Example 1 | 8 μm | 16 μm | 13 s | 260 s | 2.2 |
| (Chromophore-Free) | | | at 2.1 kV | at 2.1 kV | |
| Comparative Example 2 | 10 μm | 10 μm | N/A | 73 s | 1.9 |
| (Chromophore-Free) | | | | at 1.5 kV | |
| (Comparative Example 3 | 15 μm | 30 μm | 21 s | 125 s | 4.0 |
| (Chromophore-Free) | | | at 4.0 kV | at 4.0 kV | |
| Comparative Example 4 | 20 μm | 20 μm | N/A | 133 s | 2.7 |
| (Chromophore-Free) | | | | at 2.5 kV | |
| Comparative Example 5 | 20 μm | 40 μm | 28 s | >1000 s | 5.0 |
| (Chromophore-Free) | | | at 5.0 kV | at 5.0 kV | |

As illustrated in TABLE 1, the grating decay time is greatly reduced by adding the chromophore into one or more polymer layers in the photorefractive devices. In Example 8, the grating decay time is reduced to 44 seconds from >1000 seconds, relative to Comparative Example 5, where both devices include two polymer layers about μm thick (or a total combined thickness of about 40 μm). Moreover, in Example 6, the grating decay time is reduced to 20 seconds from 125 seconds, relative to Comparative Example 3, where both devices include two polymer layers about 15 μm thick (or a total combined thickness of about 30 μm).

### Example 9

A photorefractive device was obtained in the same manner as in Example 1 except that the photorefractive material and the two chromophore-doped APC polymer layers included PNO2 as the chromophore, rather than 7-FDCST. The chromophore doped polymer layers were about 11 μm thick (or a total combined thickness of 22 μm) and contained about 1% PNO2 each.

### Comparative Example 6

A photorefractive device was obtained in the same manner as in the Comparative Example 1 except that the photorefractive material included PNO2 as the chromophore. The two polymer layers were about 10 μm thick. Thus, the combined total thickness of the polymer layers was about 20 μm. The polymer layers were not doped with chromophore.

The performance of each device is summarized as follows in Table 2.

TABLE 2
Grating Response Time, Decay Time, and Bias
Peak Voltage of Photorefractive Device

| | Individual | Total | Grating | Grating | |
|---|---|---|---|---|---|
| | Polymer | Thickness | Response | Decay | |
| | Layer | of Polymer | Time | Time | Bias Peak |
| Example | Thickness | Layers | (Second) | (Second) | (kV) |
| Example 9 | 11 μm | 22 μm | 18 s | 16 s | 5 |
| (+1% Chromophore PNO2) | | | at 5.5 kV | at 5.5 kV | |
| Comparative Example 6 | 10 μm | 20 μm | 18 s | 36 s | 5 |
| (Chromophore-Free) | | | at 4.6 kV | at 4.6 kV | |

As illustrated in Table 2, the grating decay time is greatly reduced by adding the chromophore PNO2 into the one or more polymer layers in the photorefractive devices. In Example 9, the grating decay time is reduced to 16 seconds from 36 seconds, relative to Comparative Example 6, where both devices include two polymer layers of about 10 to 11 μm thick (or a total combined thickness of about 20 to 22 μm).

### Example 10

A photorefractive device was obtained in the same manner as in Example 1 except that it contains two 1% PMAc chromophore-doped APC polymer layers with a thickness of 11 μm. Also, the photorefractive material included PNO2 as the chromophore.

### Example 11

A photorefractive device was obtained in the same manner as in Example 1 except that it contains two 10% PMAc chromophore-doped APC polymer layers with a thickness of 12 μm. Also, the photorefractive material included PNO2 as the chromophore.

TABLE 3
Grating Response Time, Decay Time, and Bias
Peak Voltage of Photorefractive Device

| | Individual | Total | Grating | Grating | |
|---|---|---|---|---|---|
| | Polymer | Thickness | Response | Decay | |
| | Layer | of Polymer | Time | Time | Bias Peak |
| Example | Thickness | Layers | (Second) | (Second) | (kV) |
| Example 10 | 11 μm | 22 μm | 18 s | 14 s | 5 |
| (+1% Chromophore PMAc) | | | at 5 kV | at 5 kV | |
| Example 11 | 12 μm | 24 μm | 11 s | 9 s | 5 |
| (+10% Chromophore | | | at 4.8 kV | at 4.8 kV | |
| PMAc) | | | | | |
| Comparative Example 6 | 10 μm | 20 μm | 18 s | 36 s | 5 |
| (Chromophore-Free) | | | at 4.6 kV | at 4.6 kV | |

As illustrated in Table 3, the grating decay time is greatly reduced by adding the chromophore PMAc into one or more polymer layers in the photorefractive devices. In Example 10 and 11, the grating decay time is reduced to 14 or 9 seconds, compared to 36 seconds in Comparative Example 6, where both devices include two polymer layers about 10 to 12 μm thick (or a total combined thickness of about 20 to 24 μm).

### Example 12

A photorefractive device was obtained in the same manner as in Example 1 except that it contains two 1% PMAc chromophore-doped APC polymer layers with a thickness of 11 μm. Also, the photorefractive material included PMAc as the chromophore.

### Example 13

A photorefractive device was obtained in the same manner as in Example 12 except that it contains two 10% PMAc chromophore-doped APC polymer layers with a thickness of 12 μm.

### Comparative Example 7

A photorefractive device was obtained in the same manner as in the Example 1 except that the photorefractive material included PMAc as the chromophore. Each of the polymer layers was about 10 μm. Thus, the combined total thickness of the polymer layers was about 20 μm. The polymer layers were not doped with chromophore.

TABLE 4
Grating Response Time, Decay Time, and Bias
Peak Voltage of Photorefractive Device

| | Individual | Total | Grating | Grating | |
|---|---|---|---|---|---|
| | Polymer | Thickness | Response | Decay | |
| | Layer | of Polymer | Time | Time | Bias Peak |
| Example | Thickness | Layers | (Second) | (Second) | (kV) |
| Example 12 | 11 μm | 22 μm | 1.5 s | 1.5 s | >8 |
| (+1% Chromophore PMAc | | | at 7 kV | at 7 kV | |
| With PMAc as chromophore | | | | | |
| in PR layer) | | | | | |
| Example 13 | 12 μm | 24 μm | 0.8 s | 1.5 s | >8 |
| (+10% Chromophore PMAc | | | at 7 kV | at 7 kV | |
| With PMAc as chromophore | | | | | |
| in PR layer)) | | | | | |
| Comparative Example 7 | 10 μm | 20 μm | 2.8 s | 1.5 s | >8 |
| (Chromophore-Free) | | | at 7 kV | at 7 kV | |

As illustrated in Table 4, the grating response time is greatly reduced by adding the chromophore PMAc into one or more polymer layers in the photorefractive devices. In Example 12 and 13, the grating response time is reduced to 1.5 or 0.8 seconds compared to 2.8 seconds in Comparative Example 7, where both devices include two polymer layers about 10 to 12 μm thick (or a total combined thickness of about 20 to 24 μm).

### Example 14

A photorefractive device was obtained in the same manner as in Example 1 except that it contains two 1% PNO2 chromophore-doped APC polymer layers with a thickness of 11 μm. Also, the photorefractive material included PMAc as the chromophore.

### Example 15

A photorefractive device was obtained in the same manner as in Example 14 except that it contains two 10% PNO2 chromophore-doped APC polymer layers with a thickness of 12 μm.

TABLE 5
Grating Response Time, Decay Time, and Bias
Peak Voltage of Photorefractive Device

| | Individual | Total | Grating | Grating | |
|---|---|---|---|---|---|
| | Polymer | Thickness | Response | Decay | |
| | Layer | of Polymer | Time | Time | Bias Peak |
| Example | Thickness | Layers | (Second) | (Second) | (kV) |
| Example 14 | 11 μm | 22 μm | 0.8 s | 1.9 s | >8 |
| (+1% Chromophore PNO2 | | | at 7 kV | at 7 kV | |
| With PMAc as chromophore | | | | | |
| in PR layer) | | | | | |
| Example 15 | 12 μm | 24 μm | 0.8 s | 0.9 s | >8 |
| (+10% Chromophore PNO2 | | | at 7 kV | at 7 kV | |
| With PMAc as chromophore | | | | | |
| in PR layer)) | | | | | |
| Comparative Example 7 | 10 μm | 20 μm | 2.8 s | 1.5 s | >8 |
| (Chromophore-Free) | | | at 7 kV | at 7 kV | |

As illustrated in Table 5, the grating response time is greatly reduced by adding the chromophore PNO2 into one or more polymer layers in the photorefractive devices. In Example 14 and 15, the grating response time is reduced to 0.8 seconds from 2.8 seconds, relative to Comparative Example 7, where both devices include two polymer layers about 10 to 12 μm thick (or a total combined thickness of about 20 to 24 μm).

Although the foregoing description has shown, described, and pointed out the fundamental novel features of the present teachings, it will be understood that various omissions, substitutions, and changes in the form of the detail of the apparatus as illustrated, as well as the uses thereof, may be made by those skilled in the art, without departing from the scope of the present teachings. Consequently, the scope of the present teachings should not be limited to the foregoing discussion, but should be defined by the appended claims. All patents, patent publications and other documents referred to herein are hereby incorporated by reference in their entirety.

1. A photorefractive device comprising:
one or more electrode layers;
a layer that comprises a photorefractive material; and
one or more polymer layers interposed between the one or more electrode layers and the photorefractive material, wherein the one or more polymer layers is doped with one or more chromophores, and wherein the one or more chromophore-doped polymer layers is non-photorefractive.

2. The photorefractive device of claim 1, wherein the photorefractive device exhibits a decreased grating decay time relative to a second photorefractive device having polymer layers that are not doped with chromophores, wherein the grating decay time is determined using a 532 nm laser beam.

3. The photorefractive device of claim 1, wherein the photorefractive device exhibits a decreased grating response time relative to a second photorefractive device having polymer layers that are not doped with chromophores, wherein the grating response time is determined using a 532 nm laser beam.

4. The photorefractive device of claim 1, wherein the one or more chromophore-doped polymer layers comprise a polymer selected from the group consisting of polymethyl methacrylate, polyimide, amorphous polycarbonate, and siloxane sol-gel.

5. The photorefractive device of claim 1, wherein the one or more chromophore-doped polymer layers comprise a chromophore selected from the group consisting of 4-homopiperidino-2-fluorobenzylidene malononitrile, 1-hexamethyleneimine-4-nitrobenzene, methyl 3-(4-(azepan-1-yl)phenyl)acrylate, and combinations thereof.

6. The photorefractive device of claim 2, wherein the photorefractive device exhibits a grating decay time of about 130 seconds or less.

7. The photorefractive device of claim 1, wherein the one or more chromophore-doped polymer layers have a total combined thickness of about 2 μm to about 40 μm.

8. The photorefractive device of claim 1, wherein the one or more chromophore-doped polymer layers have a total combined thickness of about 10 μm to about 20 μm.

9. The photorefractive device of claim 1, wherein the one or more electrode layers comprise a conducting film independently selected from the group consisting of metal oxides, metals, and organic films, wherein the conducting film has an optical density of about 0.2 or less.

10. The photorefractive device of claim 1, wherein the photorefractive material comprises polymers or inorganic substances, and wherein the photorefractive material has a refractive index of about 1.7.

11. The photorefractive device of claim 1, further comprising a substrate on one side of the first electrode layer and the chromophore-doped polymer layer on the other side of the first electrode layer, wherein the substrate comprises at least one of soda lime glass, silica glass, borosilicate glass, gallium nitride, gallium arsenide, sapphire, quartz glass, polyethylene terephthalate, and polycarbonate.

12. The photorefractive device of claim 1, comprising:
a first electrode layer and a second electrode layer disposed on opposite sides of the photorefractive material;
a first chromophore-doped polymer layer interposed between the first electrode layer and the photorefractive material; and
a second chromophore-doped polymer layer interposed between the second electrode layer and the photorefractive material.

13. The photorefractive device of claim 12, further comprising:
a first substrate disposed on a side of the first electrode layer opposite the photorefractive material; and
a second substrate disposed on a side of the second electrode layer opposite the photorefractive material,
wherein the first substrate and the second substrate each independently comprise a material selected from the group consisting of soda lime glass, silica glass, borosilicate glass, gallium nitride, gallium arsenide, sapphire, quartz glass, polyethylene terephthalate, and polycarbonate.

14. The photorefractive device of claim 13, wherein both the first substrate and the second substrate exhibit an index of refraction of about 1.5 or less.

15. A method for fabricating a photorefractive device, comprising interposing a first chromophore-doped polymer layer between a first electrode layer and a photorefractive material, wherein the first chromophore-doped polymer layers is non-photorefractive.

16. The method of claim 15, further comprising interposing a second chromophore-doped polymer layer between a second electrode layer and the photorefractive material, wherein the second chromophore-doped polymer layers is non-photorefractive, and wherein the photorefractive device has the first electrode layer and the second electrode layer on opposite sides of the photorefractive material.

17. The method of claim 15, further comprising:
applying a mixture to the first electrode layer, wherein said mixture comprises a chromophore and a polymer dispersed in a solvent; and
removing the solvent from the applied mixture to form the first chromophore-doped polymer layer on the first electrode layer.

18. The method of claim 17, wherein the mixture is prepared by a process comprising:
substantially dissolving about 10% to 45% by weight of the polymer in the solvent to obtain a polymer solution; and
intermixing about 0.1 to about 10 parts by weight of the chromophore relative to 100 parts of the total polymer and chromophore into the polymer solution to obtain the mixture.

19. The method of claim 17, wherein the chromophore is selected from the group consisting of 4-homopiperidino-2-fluorobenzylidene malononitrile, 1-hexamethyleneimine-4-nitrobenzene, methyl 3-(4-(azepan-1-yl)phenyl)acrylate, and combinations thereof.

20. The method of claim 17, wherein the polymer is amorphous polycarbonate (APC).
